(19) United States
(12) Patent Application Publication
(10) Pub. No.: US 2025/0388032 A1
(43) Pub. Date: Dec. 25, 2025

(54) MEDIUM TRANSPORT DEVICE AND PRINTING DEVICE

(71) Applicant: SEIKO EPSON CORPORATION, Tokyo (JP)

(72) Inventors: Satoshi NAKATA, MATSUMOTO-SHI (JP); Katsumi YAMADA, MATSUMOTO-SHI (JP)

(21) Appl. No.: 19/225,189

(22) Filed: Jun. 2, 2025

(30) Foreign Application Priority Data
Jun. 4, 2024 (JP) 2024-090499

(51) Int. Cl. B41J 11/70; B41J 11/66; B41J 13/10; B41J 15/04; B41J 29/13

(52) U.S. Cl. CPC B41J 11/706; B41J 11/663; B41J 13/103; B41J 15/04; B41J 29/13

(57) ABSTRACT

A medium transport device includes a transport section that transports a medium, a cutting section that cuts the medium, and a movement section that reciprocates the cutting section. The cutting section includes a cutter unit and a mount section to which the cutter unit is attachable and detachable. The mount section includes an attachment section to which the cutter unit is attached, a cover section configured to be displaced between a closed state and an opened state, and an interference section. The interference section is positioned at a non-obstructing position for not obstructing displacement of the cover section from the opened state to the closed state when the cutter unit is attached to the attachment section, and is positioned at an obstructing position for obstructing displacement of the cover section from the opened state to the closed state when the cutter unit is not attached to the attachment section.

The present application is based on, and claims priority from JP Application Serial Number 2024-090499, filed Jun. 4, 2024, the disclosure of which is hereby incorporated by reference herein in its entirety.

### BACKGROUND

### 1. Technical Field

The present disclosure relates to a medium transport device and a printing device.

### 2. Related Art

Research and development have been carried out on a printing device for printing an image on a print medium.

In this regard, a printing device is known in which a cutter unit for cutting a print medium such as roll paper can be attached and detached (refer to JP-A-2013-086235).

Here, in the printing device as described in JP-A-2013-086235, if the cutter unit is forgotten to be mounted, an operational failure may occur.

### SUMMARY

One aspect of the present disclosure to overcome the above-described problem is a medium transport device including a transport section that transports a medium; a cutting section that cuts the medium transported by the transport section; and a movement section that reciprocates the cutting section in a movement direction intersecting a transport direction in which the medium is transported, wherein the cutting section includes a cutter unit including a cutter, and a mount section to which the cutter unit is attachable and detachable, the mount section includes an attachment section to which the cutter unit is attached, a cover section configured to be displaced between a closed state in which the cover section covers the attachment section and an opened state in which the cover section does not cover the attachment section, and an interference section configured to move between an obstructing position where the interference section interferes with the cover section to obstruct displacement of the cover section from the opened state to the closed state, and a non-obstructing position where the interference section does not interfere with the cover section not to obstruct displacement of the cover section from the opened state to the closed state, and when the cutter unit is attached to the attachment section, the interference section is positioned at the non-obstructing position and does not obstruct displacement of the cover section from the opened state to the closed state, and when the cutter unit is not attached to the attachment section, the interference section is positioned at the obstructing position and obstructs displacement of the cover section from the opened state to the closed state.

One aspect of the present disclosure is a printing device including the above-described medium transport device and a printing section that prints an image on the medium transported by the transport section.

### BRIEF DESCRIPTION OF THE DRAWINGS

FIG. 1 is a perspective view showing an example of appearance including a front surface of a printing device 1 according to an embodiment.

FIG. 2 is a perspective view showing an example of appearance including a rear surface of the printing device 1 shown in FIG. 1.

FIG. 3 is a perspective view showing an example of the printing device 1 in a case where an opening and closing cover BD opens a rear surface opening.

FIG. 4 is a side view showing an example of a configuration of a cutting section CT.

FIG. 5 is a perspective view of the cutting section CT shown in FIG. 4.

FIG. 6 is a side cross-sectional view showing an example of a configuration of a paper feed tray TR.

FIG. 7 is a perspective view showing an example of the printing device 1 in a case where the cutting section CT is positioned at a home position.

FIG. 8 is a perspective view showing an example of the printing device 1 in a case where the cutting section CT is positioned at a replacement position.

FIG. 9 is a perspective view showing an example of a state of the cutting section CT when a cutter unit CU is replaced.

FIG. 10 is a top view showing an example of the cutting section CT when the cutter unit CU is attached to an attachment section AT.

FIG. 11 is a top view showing an example of the cutting section CT when the cutter unit CU is not attached to the attachment section AT.

FIG. 12 is a perspective view showing an example of a state in which a protrusion section TR1 interferes with an upper surface of a contact member CN1 during displacement of a cover section CV from an opened state to a closed state.

FIG. 13 is a diagram showing an example of a configuration of a dummy cutter unit DCU.

FIG. 14 is a perspective view showing an example of the printing device 1 including an accommodation section CM.

FIG. 15 is a perspective view showing an other example of the printing device 1 including the accommodation section CM.

FIG. 16 is a diagram showing an example of a hardware configuration of the printing device 1.

FIG. 17 is a diagram showing an example of a process flow performed by the printing device 1 when an operation of instructing replacement of the cutter unit CU is received.

FIG. 18 is a perspective view showing an example of a state in which the cover section CV, which is not in the closed state, is in contact with a restriction member SLD.

FIG. 19 is a perspective view showing an other example of a state of the cutting section CT when the cutter unit CU is replaced.

FIG. 20 is a top view showing an other example of the cutting section CT when the cutter unit CU is attached to the attachment section AT.

FIG. 21 is a top view showing an other example of the cutting section CT when the cutter unit CU is not attached to the attachment section AT.

FIG. 22 is a perspective view showing an example of a state in which a protrusion section TR2 interferes with a cover section CV during displacement of the cover section CV from the opened state to the closed state.

FIG. 23 is a perspective view showing still an other example of a state of the cutting section CT when the cutter unit CU is replaced.

FIG. 24 is a top view showing still an other example of the cutting section CT when the cutter unit CU is attached to the attachment section AT.

FIG. 25 is a top view showing an example of a state of the cutting section CT in which the cover section CV is in the closed state by inserting a protrusion section TR3 into an opening H3.

FIG. 26 is a side cross-sectional view of the cutting section CT shown in FIG. 25.

FIG. 27 is a top view showing still an other example of the cutting section CT when the cutter unit CU is not attached to the attachment section AT.

FIG. 28 is a side cross-sectional view showing an example of a state in which a protrusion section TR3 interferes with a contact member CN3 during displacement of the cover section CV from the opened state to the closed state.

### DESCRIPTION OF EMBODIMENTS

### Embodiment

Hereinafter, embodiments of the present disclosure will be described with reference to the drawings.

### Outline of Printing Device According to Embodiment

First, an outline of a printing device according to an embodiment will be described.

The printing device according to an embodiment includes a medium transport device and a printing section. The medium transport device includes a transport section, a cutting section, and a movement section. The transport section transports a medium. The cutting section cuts the medium transported by the transport section. The movement section reciprocates the cutting section in a movement direction intersecting a transport direction in which the medium is transported. The cutting section includes a cutter unit including a cutter and a mount section to which the cutter unit is attachable and detachable. The mount section includes an attachment section, a cover section, and an interference section. The cutter unit is attached to the attachment section. The cover section is displaceable between a closed state in which the cover section covers the attachment section and an opened state in which the cover section does not cover the attachment section. The interference section is a movable member between an obstructing position where the interference section interferes with the cover section to obstruct displacement of the cover section from the opened state to the closed state, and a non-obstructing position where the interference section does not interfere with the cover section not to obstruct displacement of the cover section from the opened state to the closed state. The interference section is positioned at the non-obstructing position when the cutter unit is attached to the attachment section, and is positioned at the obstructing position when the cutter unit is not attached to the attachment section. By this, the printing device can be prevented from operating in a state where the cutter unit is not mounted.

Hereinafter, a configuration of the printing device according to the embodiment will be described in detail.

### Configuration of Printing Device According to Embodiment

Hereinafter, a configuration of the printing device according to the embodiment will be described by taking a printing device 1 as an example.

In the embodiment, for convenience of description, a user of the printing device 1 will be simply referred to as a user. In the present specification, the three-dimensional coordinate system TC is a three-dimensional orthogonal coordinate system indicating directions in a drawing in which the three-dimensional coordinate system TC is drawn. Hereinafter, for convenience of description, an X-axis in the three-dimensional coordinate system TC is simply referred to as the X-axis. Hereinafter, for convenience of description, a Y-axis in the three-dimensional coordinate system TC is simply referred to as the Y-axis. Hereinafter, for convenience of description, a Z-axis in the three-dimensional coordinate system TC is simply referred to as the Z-axis. Hereinafter, as an example, a case will be described in which a negative direction of the Z-axis coincides with the gravity direction. Therefore, hereinafter, for convenience of description, a positive direction of the Z-axis will be referred to as an upward direction or simply as upward, and a negative direction of the Z-axis will be referred to as a downward direction or simply as downward. For convenience of description, a positive direction of the X-axis is referred to as a front direction or simply front, and a negative direction of the X-axis is referred to as a rear direction or simply rear.

Hereinafter, for convenience of description, a surface on a positive direction side of the X-axis among surfaces of the printing device 1 will be referred to as a front surface of the printing device 1 and a surface on a negative direction side of the X-axis among surfaces of the printing device 1 will be referred to as a rear surface of the printing device 1. A back surface of the printing device 1 may be referred to as the rear surface of the printing device 1. In the following description, a case where an object is viewed in a certain direction is referred to as a case where the object is viewed in that direction.

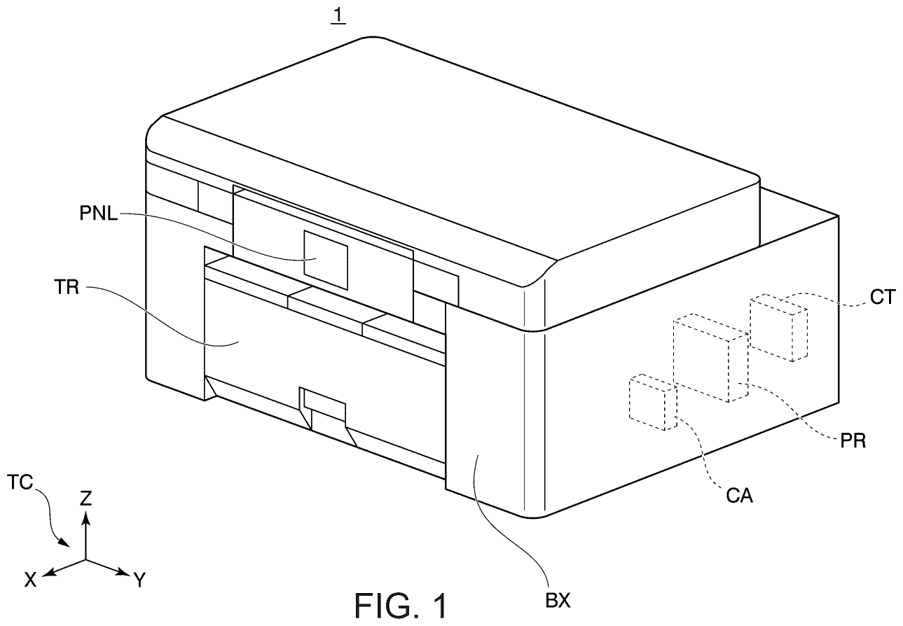

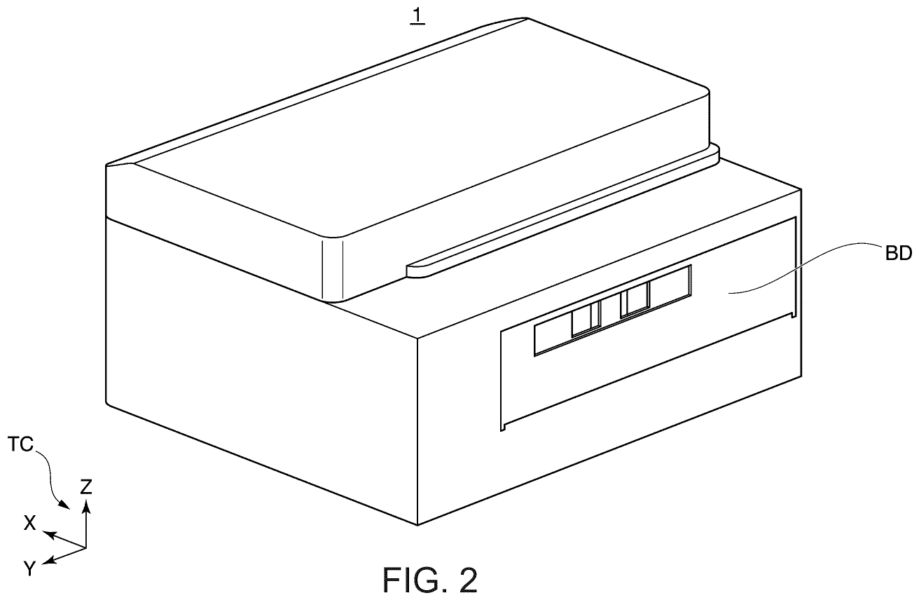

FIG. 1 is a perspective view showing an example of appearance including the front surface of the printing device 1 according to the embodiment. FIG. 2 is a perspective view showing an example of appearance including the rear surface of the printing device 1 shown in FIG. 1.

The printing device 1 uses roll paper RP, which is drawn out from a wound body RB around which the roll paper RP is wound, or cut paper CP, as a print medium, and prints an image on the print medium. The cut paper CP may be any medium as long as the medium is a cut sheet-like medium such as a cut printing sheet or a sticker mount.

The printing device 1 includes an operation section PNL, a printing section PR, a paper feed tray TR, a transport section CA, a cutting section CT, and an opening and closing cover BD. The printing device 1 may include other members, other devices, and the like in addition to the operation section PNL, the printing section PR, the paper feed tray TR, the transport section CA, the cutting section CT, and the opening and closing cover BD. In FIG. 1, in order to simplify the drawing, each of the printing section PR, the transport section CA, and the cutting section CT is drawn as a rectangular parallelepiped-shaped object. In FIG. 1, the printing section PR, the transport section CA, and the cutting section CT are drawn at positions different from their actual positions in order to simplify the drawing. In FIG. 2, the printing section PR, the transport section CA, and the cutting section CT are omitted in order to simplify the drawing.

The operation section PNL is an input device that receives an operation. The operation section PNL is, for example, a touch screen, but instead of or in addition to this, it may be configured to include a hardware key such as a button. As shown in FIG. 1, in the printing device 1, the operation section PNL is provided above the paper feed tray TR on the front surface of the printing device 1. The operation section PNL may be provided at an other position on the front surface of the printing device 1. The operation section PNL may be provided on a surface other than the front surface among surfaces of the printing device 1.

The printing section PR prints an image on a print medium transported from the paper feed tray TR by the printing device 1.

The paper feed tray TR is a tray capable of accommodating at least one of the above-described wound body RB and the one or more sheets of cut paper CP as the print medium to be transported by the printing device 1. That is, the paper feed tray TR is a tray capable of accommodating only the wound body RB, accommodating only the one or more sheets of cut paper CP, and accommodating both the wound body RB and the one or more sheets of cut paper CP. The paper feed tray TR is a tray that can slide in parallel with a predetermined pulling-out direction between a predetermined mounted position and a predetermined pulled-out position. Hereinafter, as an example, a case where the pulling-out direction coincides with a positive direction of the X-axis will be described. The paper feed tray TR may be removable from a housing of the printing device 1 or may be non-removable from the housing of the printing device 1. The details of a configuration of the paper feed tray TR will be described later.

The transport section CA transports at least one of the roll paper RP drawn out from the wound body RB accommodated in the paper feed tray TR or at least one of the one or more sheets of cut paper CP accommodated in the paper feed tray TR as a print medium. The transport section CA includes a plurality of rollers, a rotation mechanism that rotates each of the plurality of rollers, and the like.

The cutting section CT cuts the roll paper RP drawn out from the wound body RB. The cutting section CT is provided at a predetermined position on a path through which the print medium transported from the paper feed tray TR by the transport section CA passes. Hereinafter, for convenience of description, the position will be referred to as a cutting position.

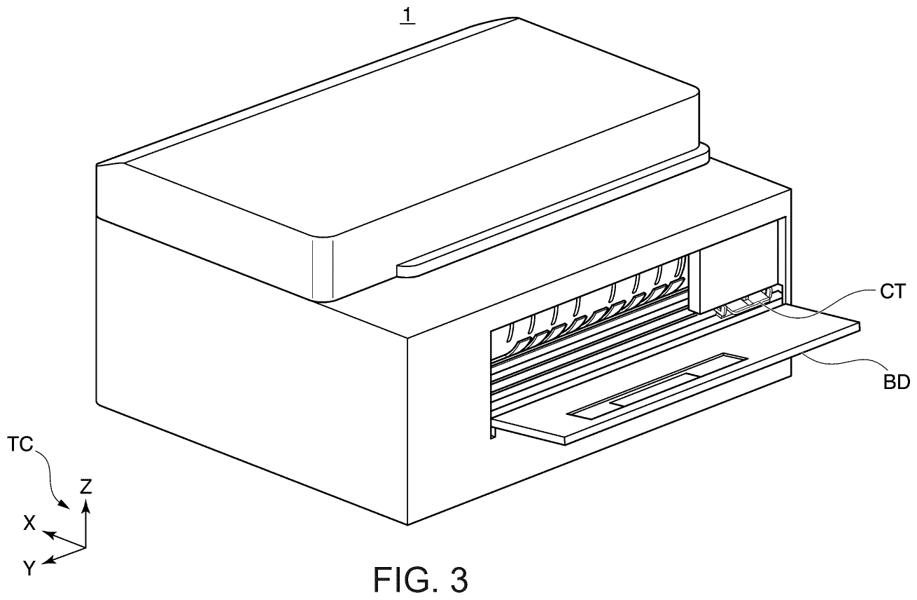

The opening and closing cover BD is a cover for opening and closing an opening formed in the rear surface of the printing device 1. Hereinafter, for convenience of description, the opening will be referred to as a rear surface opening. In the example shown in FIG. 2, the opening and closing cover BD closes the rear surface opening. In this case, a user cannot see the inside of the printing device 1 through the rear surface opening. On the other hand, FIG. 3 is a perspective view showing an example of the printing device 1 in a case where the opening and closing cover BD opens the rear surface opening. In this case, a user can see the inside of the printing device 1 through the rear surface opening. In the example shown in FIG. 3, the opening and closing cover BD is provided on the housing of the printing device 1 so as to be rotatable about an axis parallel to the Y-axis, but may be provided so as to be rotatable about another axis.

A user can expose the cutting position by opening the rear surface opening by the opening and closing cover BD. Therefore, the cutting position is a position on a rear surface side of the printing device 1 among positions in the housing of the printing device 1. In FIG. 3, since the opening and closing cover BD opens the rear surface opening, the cutting section CT is exposed through the rear surface opening. The rear surface opening is an opening used by a user to replace a cutter when, for example, the sharpness of the cutter included in the cutting section CT becomes dull.

### Configuration of Cutting Section

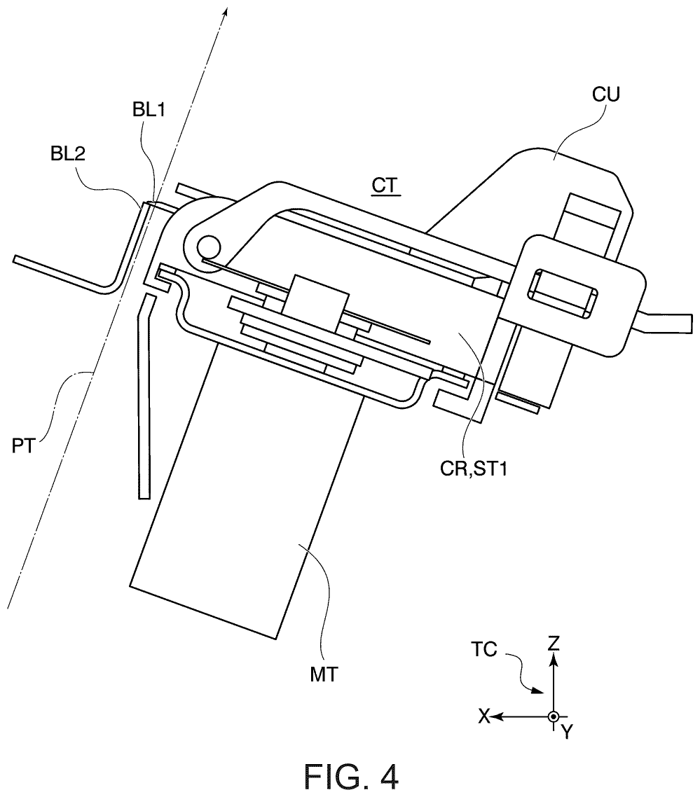

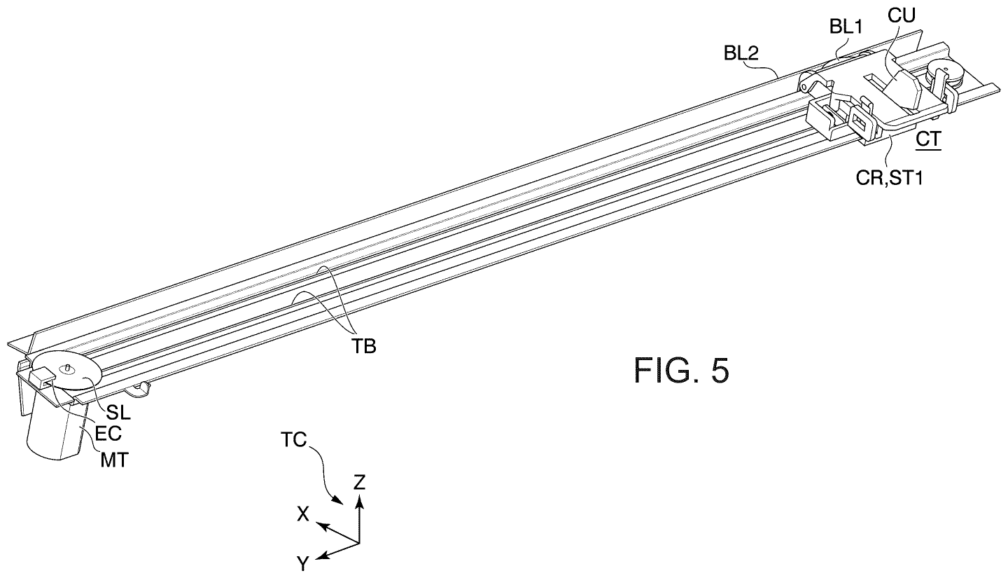

Hereinafter, a configuration of the cutting section CT will be described with reference to FIGS. 4 and 5.

FIG. 4 is a side view showing an example of a configuration of the cutting section CT. FIG. 5 is a perspective view of the cutting section CT shown in FIG. 4. The dotted arrow PT shown in FIG. 4 indicates at least a portion of the path of the print medium passing through the cutting position.

As shown in FIGS. 4 and 5, the cutting section CT is mounted on a movement section CR. That is, the printing device 1 includes the movement section CR together with the cutting section CT. The movement section CR is a member that reciprocates the cutting section CT in a movement direction that intersects a transport direction in which the print medium is transported in the printing device 1, and is, for example, a carriage. Hereinafter, as an example, a case where the transport direction and the movement direction are orthogonal to each other will be described. In the following, as an example, a case where the movement direction is parallel to the Y-axis will be described.

The movement section CR includes, for example, a motor MT, a driven pulley hidden behind the cutting section CT in FIG. 5 and not seen, a timing belt TB stretched between the motor MT and the driven pulley, a scale SL, and an encoder EC. The movement section CR includes a base (not shown) on which the motor MT, the driven pulley, the timing belt TB, the scale SL, and the encoder EC are fixed, and which extends parallel to the movement direction. The movement section CR may be configured to include another member or the like in addition to the motor MT, the driven pulley, the timing belt TB, the scale SL, the encoder EC, and the base.

The movement section CR is fixed to the timing belt TB and is capable of reciprocating in parallel with the Y-axis. Therefore, the cutting section CT mounted on the movement section CR can also reciprocate parallel to the Y-axis with the movement section CR. A position of the movement section CR is detected by the disk-shaped scale SL and the encoder EC. Therefore, the printing device 1 can perform a process according to the detected position of the movement section CR, and can move the movement section CR to a desired position. That is, the printing device 1 can move the cutting section CT to a desired position.

Here, the cutting section CT includes a cutter unit CU including a movable blade BL1 as a cutter, a fixed blade BL2 that is provided on the base of the movement section CR and that extends parallel to the base, and a mount section ST1 to which the cutter unit CU can be attached and detached. Hereinafter, as an example, as shown in FIGS. 4 and 5, a case where the mount section ST1 is integrally formed with the movement section CR will be described. The mount section ST1 may be configured separately from the movement section CR. Details of a configuration of the mount section ST1 will be described later. The cutting section CT reciprocates with the movement section CR while keeping the movable blade BL1 in contact with the fixed blade BL2. By this, the cutting section CT can cut the roll paper RP by sandwiching the roll paper RP between the movable blade BL1 and the fixed blade BL2.

### Configuration of Paper Feed Tray

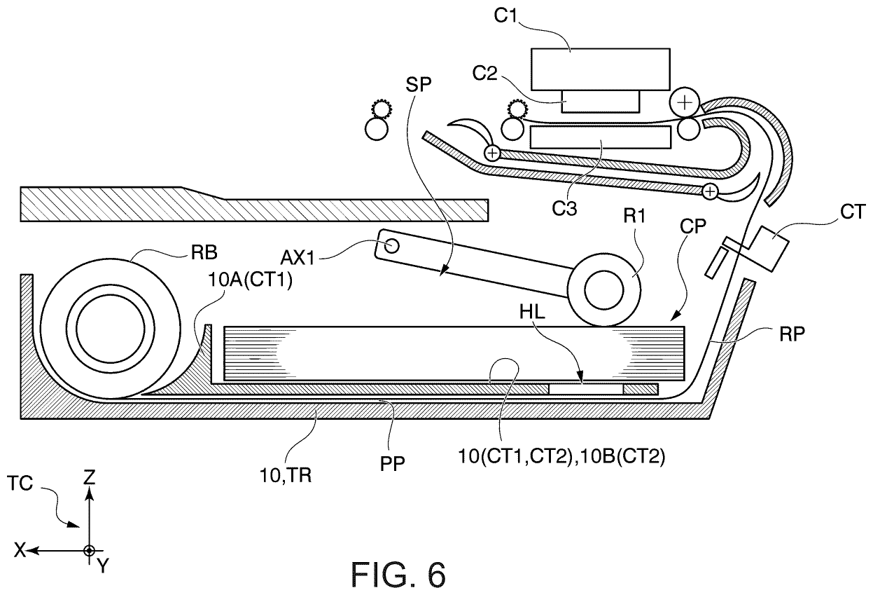

Hereinafter, a configuration of the paper feed tray TR will be described with reference to FIG. 6. FIG. 6 is a side cross-sectional view showing an example of the configuration of the paper feed tray TR. In the example shown in FIG. 6, a plurality of sheets of the cut paper CP are accommodated in the paper feed tray TR together with the wound body RB.

In the example shown in FIG. 6, the paper feed tray TR is a box-shaped tray in which a recess section opened upward is formed. The shape of the paper feed tray TR may be another shape instead of the shape shown in FIG. 6. A space SP in the recess section of the paper feed tray TR is a space capable of accommodating the one or more sheets of cut paper CP together with the wound body RB. That is, the paper feed tray TR is a tray capable of accommodating the one or more sheets of cut paper CP together with the wound body RB. Hereinafter, for convenience of description, a member related to accommodation of the wound body RB among members constituting the paper feed tray TR will be referred to as a first accommodation section CT1. Hereinafter, for convenience of description, a member related to accommodation of the one or more sheets of cut paper CP among members constituting the paper feed tray TR will be described as a second accommodation section CT2. A part of the first accommodation section CT1 may be integrally formed with a part of the second accommodation section CT2. The first accommodation section CT1 may be a member separate from the second accommodation section CT2.

The paper feed tray TR is supported by a housing BX so as to be slidable in parallel to the pulling-out direction between the mounted position and the pulled-out position. The housing BX may be configured separately from the printing device 1 or may be configured integrally with the printing device 1. Hereinafter, as an example, as shown in FIG. 1, a case where the housing BX is integrally configured with the printing device 1 will be described. Here, the mounted position is, among positions in the housing BX where the paper feed tray TR can slide, a position at which the roll paper RP is drawn out from the paper feed tray TR by the printing device 1. The pulled-out position is, among positions in the housing BX where the paper feed tray TR can slide, a position separated from the mounted position by a predetermined distance in the pulling-out direction. The predetermined distance can be any distance. For example, among positions in the housing BX where the paper feed tray TR can slide, the pulled-out position is the position furthest in the pulling-out direction. The paper feed tray TR may be removable from the housing BX or may be non-removable from the housing BX. In a case where the housing BX is configured separately from the printing device 1, the housing BX may be configured to be provided in the paper feed tray TR.

In a case where the paper feed tray TR is mounted on the printing device 1, a surface of the paper feed tray TR on a positive direction side of the X-axis constitutes a part of the front surface of the printing device 1. Therefore, hereinafter, for convenience of description, a surface on a positive direction side of the X-axis among surfaces of the paper feed tray TR will be referred to as a front surface of the paper feed tray TR.

Here, the wound body RB is accommodated in the paper feed tray TR so as to be positioned closer to the front surface of the paper feed tray TR than the one or more sheets of cut paper CP. That is, the first accommodation section CT1 is positioned closer to the front surface of the paper feed tray TR than is the second accommodation section CT2. The wound body RB is accommodated in the paper feed tray TR so that an axis of the wound body RB is parallel to the front surface of the paper feed tray TR. The axis of the wound body RB is a rotation axis of the wound body RB, which rotates when the roll paper RP is drawn out from the wound body RB accommodated in the first accommodation section CT1. In the example shown in FIG. 6, within the space SP, the wound body RB is supported by a part of a bottom surface of the paper feed tray TR and by a member 10 provided above the bottom surface of the paper feed tray TR. Therefore, as shown in FIG. 6, a connection portion connects the lowermost surface among the surfaces that form the space SP and the surface among of surfaces forming the space SP that is positioned closest to a front surface side of the paper feed tray TR. The connection portion is curved along an outer peripheral surface of the wound body RB in a direction orthogonal to the axis of the wound body RB. Hereinafter, for convenience of description, the connection portion will be referred to as a target connection portion.

The member 10 includes a wound body support portion 10A and a cut paper support portion 10B. The wound body support portion 10A is a portion of member 10 that includes a curved surface curved along the outer peripheral surface of the wound body RB in a direction orthogonal to the axis of the wound body RB. Therefore, the wound body RB is rotatably supported by the target connection portion and the curved surface within the space SP. Therefore, in the example shown in FIG. 6, the first accommodation section CTI is constituted by the target connection portion and the wound body support portion 10A. The cut paper support portion 10B is a plate-shaped portion among portions of the member 10, and is a portion including a placement surface on which the one or more sheets of cut paper CP are supported. Therefore, in the example, the second accommodation section CT2 is constituted by the cut paper support portion 10B. A lower surface of the wound body support portion 10A and a lower surface of the cut paper support portion 10B are connected so as not to have a step. The wound body support portion 10A and the cut paper support portion 10B may be configured separate from each other without being connected.

The member 10 is separated upward from the lowermost surface of surfaces forming the space SP. That is, in the paper feed tray TR, a gap exists between the surface and the member 10. This gap functions as a roll paper passage path PP through which passes the roll paper RP that is drawn from the wound body RB into the printing device 1. FIG. 6 shows a state in which the roll paper RP is being drawn through the roll paper passage path PP and into the printing device 1.

An opening HL is formed in the cut paper support portion 10B. The opening HL is formed so that a paper feed roller R1 can come into contact with the roll paper RP passing through the roll paper passage path PP when no cut paper CP is accommodated in the second accommodation section CT2. The opening HL may be openable and closable by a member such as a flap.

Here, the one or more sheets of cut paper CP accommodated in the paper feed tray TR mounted on the printing device 1 are transported into the printing device 1 one by one by the paper feed roller R1 included in the printing device 1. A rotation axis of the paper feed roller R1 is parallel to an axis of the wound body RB. The paper feed roller R1 is provided in the printing device 1 so as to be swingable about a rotation shaft AX1 that is positioned above the paper feed roller R1 on a front surface side and that is parallel to the axis of the wound body RB.

The roll paper RP, which is drawn out from the wound body RB accommodated in the paper feed tray TR mounted on the printing device 1, is also transported into the printing device 1 by the paper feed roller R1. In a case where the cut paper CP is not accommodated in the paper feed tray TR, the paper feed roller R1 comes into contact with the roll paper RP drawn out from the wound body RB to the roll paper passage path PP by a hand of a user through the opening HL. By this, the paper feed roller R1 can transport the roll paper RP into the printing device 1.

As shown in FIG. 6, the roll paper RP transported by the paper feed roller R1 passes between a print head C2 supported by a carriage C1 of the printing device 1 and a platen C3 of the printing device 1, thereby printing an image. The carriage C1, the print head C2, and the platen C3 each constitute the printing section PR in the printing device 1. Of the roll paper RP drawn out from the wound body RB, the roll paper RP after an image is printed by the printing section PR is separated from the roll paper RP drawn out from the wound body RB before an image is printed by the printing section PR by the cutting section CT that cuts the roll paper RP. For this reason, in the printing device 1, the cutting section CT is positioned on an upstream side of a transport path of the roll paper RP from the printing section PR.

As described above, in the paper feed tray TR, each of the roll paper RP drawn out from the wound body RB and the one or more sheets of cut paper CP is transported by the paper feed roller R1.

### About Home Position and Replacement Position

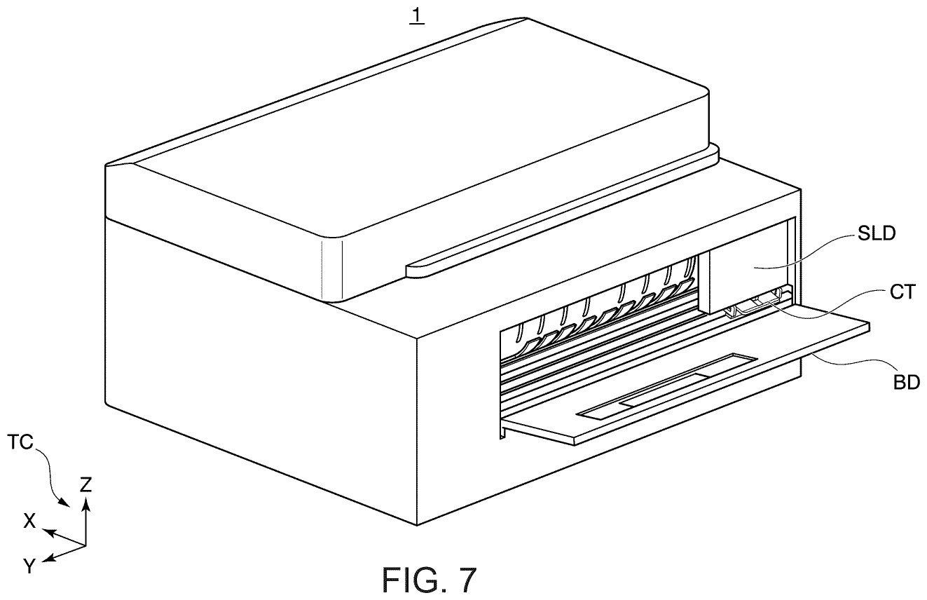

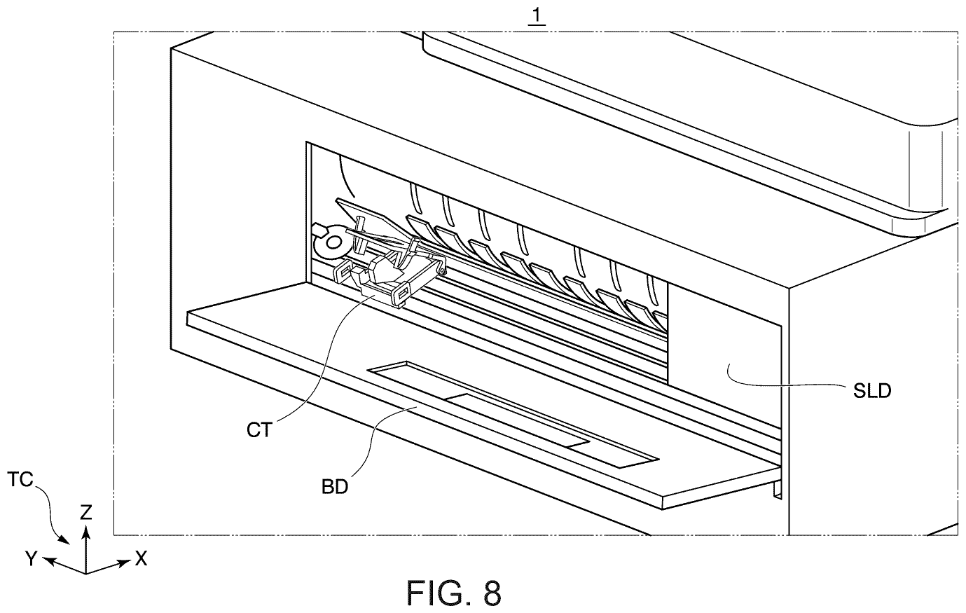

Hereinafter, with reference to FIGS. 7 and 8, a predetermined home position and a predetermined replacement position among positions at which the cutting section CT can be positioned will be described. FIG. 7 is a perspective view showing an example of the printing device 1 in a case where the cutting section CT is positioned at the home position. FIG. 8 is a perspective view showing an example of the printing device 1 in a case where the cutting section CT is positioned at the replacement position.

Here, the home position is a position determined in advance as a position at which the cutting section CT starts an operation of cutting the roll paper RP among positions at which the cutting section CT can be positioned. In the example shown in FIG. 7, the home position is a position where the cutting section CT is positioned in FIG. 7. That is, in the example, the home position is a position that is positioned on the most negative direction side of the Y-axis among positions at which the cutting section CT can be positioned. However, in the example, a part of the cutting section CT positioned at the home position is covered by a plate-shaped restriction member SLD provided in the printing device 1 so as to cover an upper side of the home position at the rear surface opening. More specifically, in the example, the cutter unit CU mounted on the mount section ST1 of the cutting section CT positioned at the home position is covered by the plate-shaped restriction member SLD provided in the printing device 1 so as to cover the upper side of the home position at the rear surface opening. Therefore, when the cutting section CT is positioned at the home position, a user cannot replace the cutter unit CU. The restriction member SLD has a function of restricting movement of the cutting section CT. This function will be described later. A surface of the plate-like restriction member SLD is a surface parallel to the rear surface of the printing device 1 in the example shown in FIGS. 7 and 8, but this is only an example, and it may be a surface non-parallel to the rear surface of the printing device 1. Instead of the plate-shaped member, the restriction member SLD may be a member of another shape having the same function as the plate-shaped restriction member SLD. In the example, the restriction member SLD is provided above a movement path of the cutting section CT, but instead of this, a configuration may be adopted in which the restriction member SLD is provided at a position other than above the movement path of the cutting section CT.

On the other hand, the replacement position is a position determined in advance as a position at which the cutter unit CU is replaced among positions at which the cutting section CT can be positioned. In the example shown in FIG. 8, the replacement position is a position at which the cutting section CT is positioned in FIG. 8. That is, in the example, the replacement position is a position that is positioned on the most positive direction side of the Y-axis among positions at which the cutting section CT can be positioned.

The replacement position is not covered by the restriction member SLD. Therefore, the cutting section CT positioned at the replacement position is exposed as shown in FIG. 8. Therefore, a user can replace the cutter unit CU when the cutting section CT is positioned at the replacement position.

The printing device 1 moves a position of the cutting section CT to either the home position or the replacement position according to a received command, instruction, operation, or the like. For example, when the printing device 1 receives a print job including a command to cause printing device 1 to print an image on a print medium, the printing device 1 moves a position of the cutting section CT to the home position. Then, the printing device 1 cuts the print medium by the cutting section CT as necessary. On the other hand, for example, when the printing device 1 receives an instruction to replace the cutter unit CU, the printing device 1 moves a position of the cutting section CT to the replacement position.

### Configuration of Mount Section

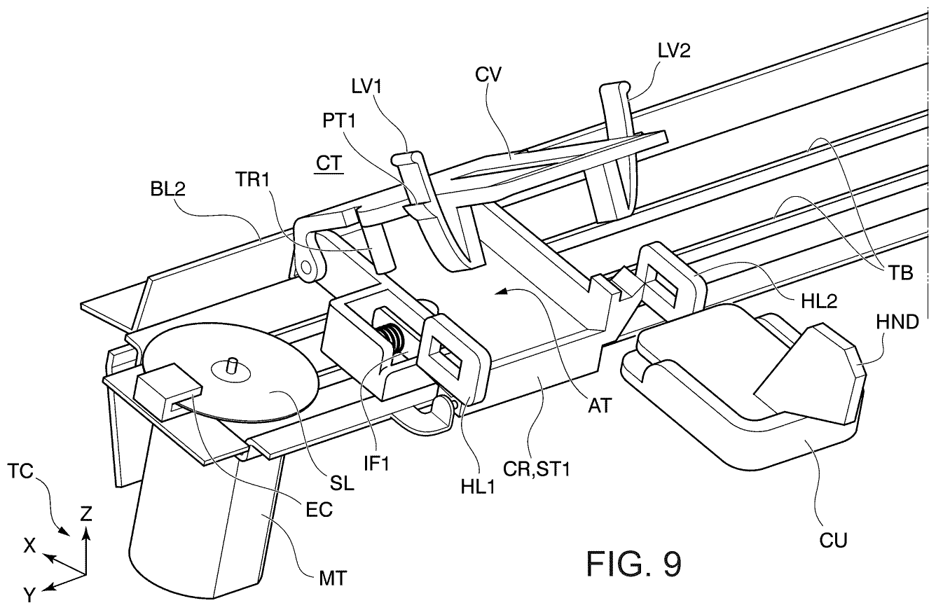

Hereinafter, with reference to FIGS. 9 to 13, a configuration of the mount section ST1 that the cutting section CT includes will be described. FIG. 9 is a perspective view showing an example of a state of the cutting section CT when the cutter unit CU is replaced.

As shown in FIG. 9, the mount section ST1 includes an attachment section AT, a cover section CV, and an interference section IF1.

The attachment section AT is a member to which the cutter unit CU is attached. The attachment section AT includes a placement surface on which the cutter unit CU is supported. On both sides of the placement surface in the movement direction of the movement section CR, side walls that sandwich and support the cutter unit CU supported on the placement surface protrude in the upward direction. Therefore, the cutter unit CU is attached to the attachment section AT by sliding on the placement surface toward a predetermined mounting direction. FIG. 9 shows the cutter unit CU just before it is attached to the attachment section AT. Therefore, the cutter unit CU shown in FIG. 9 is not in contact with the placement surface.

The cover section CV is a member that can be displaced into a closed state that covers the attachment section AT and an opened state that does not cover the attachment section AT. The cover section CV is a member that fixes the cutter unit CU supported on the placement surface by sandwiching the cutter unit CU between the cover section CV and the placement surface. In the example shown in FIG. 9, the cover section CV is pivotable around a pivot axis parallel to the movement direction of the movement section CR, and is provided on side walls of the attachment section AT. For this reason, a user attaches the cutter unit CU to the attachment section AT, and then moves the cover section CV by hand to displace the cover section CV from the opened state to the closed state. By this, the user can mount the cutter unit CU to the mount section ST1. Note that, as shown in FIG. 9, the cutter unit CU includes a gripping section HND. The gripping section HND is a member that is gripped by a user when the cutter unit CU is lifted. By this, the printing device 1 can improve the positioning accuracy of the cutter unit CU with respect to the attachment section AT while improving the gripping property of the cutter unit CU. The gripping section HND is inserted into an opening of the cover section CV during a process of displacement of the cover section CV from the opened state to the closed state. Therefore, the gripping section HND does not restrict displacement of the cover section CV from the opened state to the closed state.

The cover section CV in the closed state is locked to the attachment section AT. Specifically, the cover section CV is locked to the attachment section AT by a lever lock including a first protruding section PT1 that engages with an opening of a first opening section HL1 provided in the attachment section AT, a first lever LV1 extending upward from the first protruding section PT1, a second protruding section PT2 that engages an opening of a second opening section HL2 provided in the attachment section AT, and a second lever LV2 extending upward from the second protruding section PT2. Here, the first protruding section PT1 protrudes from the cover section CV toward a positive direction of the Y-axis. On the other hand, the second protruding section PT2 protrudes from the cover section CV toward a negative direction of the Y-axis. Therefore, the first protruding section PT1 and the first lever LV1, and second protruding section PT2 and the second lever LV2 face each other. However, in FIG. 9, the second protruding section PT2 is hidden behind the second lever LV2 and is not seen. When the cover section CV is displaced from the opened state to the closed state, the first protruding section PT1 engages with the opening of the first opening section HL1. When the cover section CV is displaced from the opened state to the closed state, the second protruding section PT2 engages with the opening of the second opening section HL2. By this, the cover section CV in the closed state is locked to the attachment section AT. Then, a user can release engagement between the first protruding section PT1 and the opening of the first opening section HL1 and engagement between the second protruding section PT2 and the opening of the second opening section HL2 by performing an operation so that an upper end of the first lever LV1 and an upper end of the second lever LV2 are brought close to each other. Therefore, the user can release lock of the cover section CV to the attachment section AT by performing an operation so that an upper end of the first lever LV1 and an upper end of the second lever LV2 are brought close to each other, and can displace the cover section CV from the closed state to the opened state by raising the cover section CV from the attachment section AT.

The interference section IF1 is a member that is movable between an obstructing position where the interference section IF1 interferes with the cover section CV to obstruct displacement of the cover section CV from the opened state to the closed state and a non-obstructing position where the interference section IF1 does not interfere with the cover section CV not to obstruct displacement of the cover section CV from the opened state to the closed state. Here, the interference section IF1 moves from the obstructing position to the non-obstructing position by being pushed by the cutter unit CU in process of attaching the cutter unit CU to the attachment section AT. By this, the cover section CV can be displaced from the opened state to the closed state without interfering with the interference section IF1. On the other hand, the interference section IF1 moves from the non-obstructing position to the obstructing position by a biasing member such as a spring in process in which the cutter unit CU is detached from the attachment section AT. By this, when the cutter unit CU is not attached to the attachment section AT, the cover section CV interferes with the interference section IF1 and cannot be displaced from the opened state to the closed state.

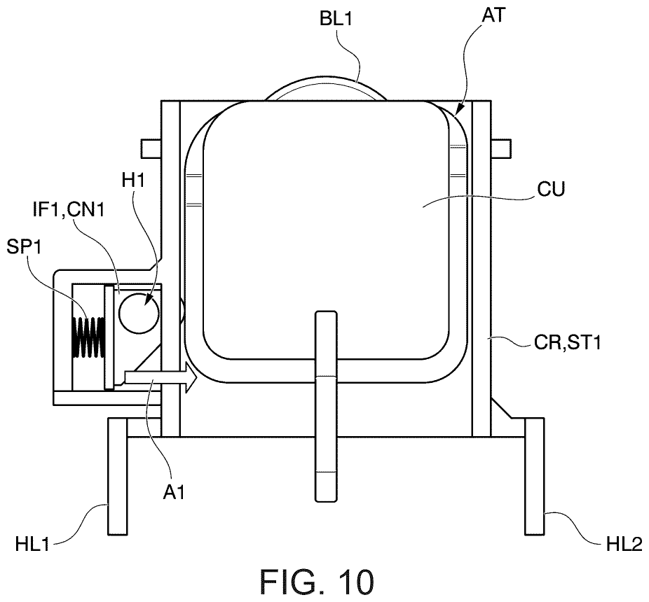

FIG. 10 is a top view showing an example of the cutting section CT when the cutter unit CU is attached to the attachment section AT. However, in FIG. 10, the cover section CV is omitted in order to clearly show the positional relationship between the cutter unit CU and the interference section IF1.

As shown in FIG. 10, the interference section IF1 includes, for example, a contact member CN1 and a biasing member SP1. The interference section IF1 may include another member in addition to the contact member CN1 and the biasing member SP1.

The contact member CN1 is a member that can contact the cutter unit CU. In the example shown in FIG. 10, the contact member CN1 is a plate-shaped member that is biased by the biasing member SP1 toward a space in which the cutter unit CU is supported in the attachment section AT. That is, the biasing member SP1 is a member that biases the contact member CN1 toward a space in which the cutter unit CU is supported in the attachment section AT, and is, for example, a spring or the like, but is not limited thereto. In the printing device 1, since the interference section IF1 includes the biasing member SP1, it is possible to realize the interference between the interference section IF1 and the cover section CV in a case where the cutter unit CU is not attached to the attachment section AT with a simple configuration. The contact member CN1 is a member including a plate-shaped portion parallel to the placement surface of the attachment section AT. Here, as described above, the cutter unit CU is attached to the attachment section AT toward the mounting direction. The contact member CN1 is inclined so as to extend further toward a biasing direction A1, in which the biasing member SP1 biases the contact member CN1, as the contact member CN1 extends further toward the mounting direction. Therefore, the interference section IF1 is pushed by the cutter unit CU when a user slides the cutter unit CU on the placement surface toward the mounting direction, and moves in a direction opposite to the biasing direction A1. As a result, the interference section IF1 moves from the obstructing position to the non-obstructing position in process of attaching the cutter unit CU to the attachment section AT. This is useful because a user can easily notice that the cutter unit CU is not properly attached to the attachment section AT without lowering the mountability of the cutter unit CU. A position where the interference section IF1 shown in FIG. 10 is positioned is an example of the non-obstructing position.

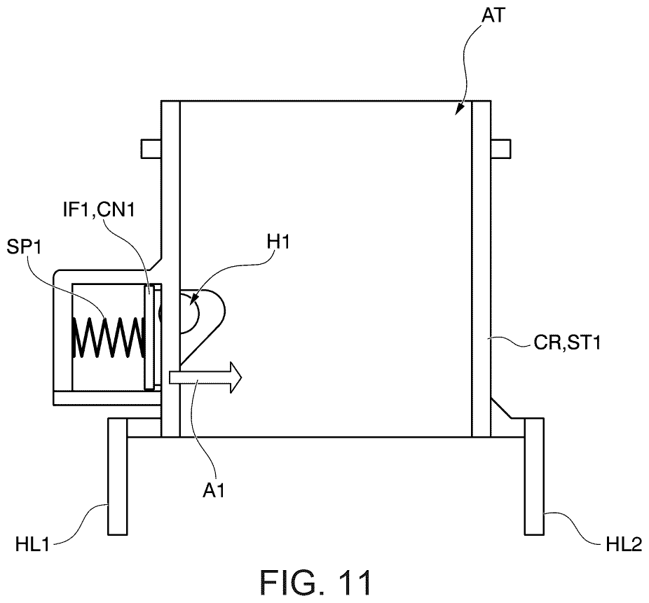

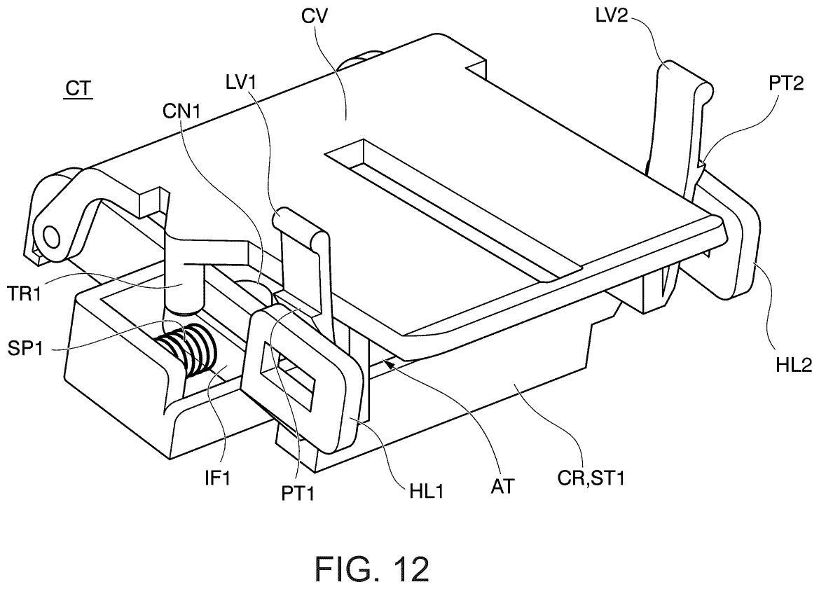

The contact member CN1 includes an opening H1. The opening H1 is an opening through which the protrusion section TR1 of the cover section CV is inserted. Here, the protrusion section TR1 is a portion among portions included in the cover section CV that protrudes toward the contact member CN1 in the cover section CV in the closed state. FIG. 9 shows the protrusion section TR1 protruding from the cover section CV in the opened state. The above-described non-obstructing position is also a position at which the protrusion section TR1 is inserted into the opening H1 in displacement of the cover section CV from the opened state to the closed state. For this reason, in a case where the contact member CN1 is not positioned at the non-obstructing position, the protrusion section TR1 is not inserted into the opening H1 and interferes with an upper surface of the contact member CN1. As a result, in the case, the cover section CV cannot be displaced from the opened state to the closed state. FIG. 11 is a top view showing an example of the cutting section CT when the cutter unit CU is not attached to the attachment section AT. However, in FIG. 11, in order to clearly show a position of the interference section IF1, the cover section CV is omitted. As shown in FIG. 11, in this case, the opening H1 is positioned on a biasing direction A1 side from a position of the opening H1 shown in FIG. 10. Therefore, as shown in FIG. 12, in displacement of the cover section CV from the opened state to the closed state, the protrusion section TR1 interferes with an upper surface of the contact member CN1 without being inserted into the opening H1. FIG. 12 is a perspective view showing an example of a state in which the protrusion section TR1 interferes with the upper surface of the contact member CN1 during displacement of the cover section CV from the opened state to the closed state. In the example shown in FIG. 12, the interference section IF1 is positioned at the obstructing position. In this case, the protrusion section TR1 is not inserted into the opening H1. As a result, as shown in FIG. 12, the protrusion section TR1 is in contact with the contact member CN1. Therefore, in the example, the cover section CV is not displaced from the opened state to the closed state. The opening H1 is an example of a first opening. The protrusion section TR1 is an example of a first protrusion section. The contact member CN1 is an example of a first contact member. The biasing member SP1 is an example of a first biasing member.

In the printing device 1 including the cutting section CT with the mount section ST1 configured as described above, the interference section IF1 is positioned at the non-obstructing position when the cutter unit CU is attached to the attachment section AT, and is positioned at the obstructing position when the cutter unit CU is not attached to the attachment section AT. By this, in a case where the cutter unit CU is not attached, since the cover section CV cannot be displaced from the opened state to the closed state, it is possible to cause a user to visually notice that the cutter unit CU is not attached to the attachment section AT. The case where the cutter unit CU is not attached is, for example, a case where a user forgets to mount the cutter unit CU. Therefore, the printing device 1 can be prevented from operating in a state where the cutter unit CU is not attached to the attachment section AT. Further, the printing device 1 can suppress an increase in the total time required for printing an image on a print medium, compared with a case where a user notices that the cutter unit CU is not attached to the attachment section AT after operating the printing device 1. The printing device 1 is capable of visually notifying a user that the cutter unit CU is not properly attached to the attachment section AT not only when the user forgets to mount the cutter unit CU, but also when the cutter unit CU is not supported at a position on the placement surface of the attachment section AT predetermined as an attached position for the cutter unit CU, because the cover section CV cannot be displaced from the opened state to the closed state. As a result, it is possible to suppress the printing device 1 from operating in a state where the cutter unit CU is not properly mounted. Further, the printing device 1 allows a user to easily position the cover section CV by inserting the protrusion section TR1 into the opening H1. This leads to improvement in the usability of the printing device 1 and is useful. In the printing device 1, since both the cover section CV and the interference section IF1 are provided in the mount section ST1, which is integrally configured with the movement section CR, it is possible to improve the position accuracy of each of the cover section CV and the interference section IF1, and it is possible to easily insert the protrusion section TR1 into the interference section IF1. This leads to suppression of occurrence of a defective product due to an assembly failure or the like, which is useful.

### Dummy Cutter Unit

The printing device 1 described above may include a configuration including a dummy cutter unit DCU. In this case, a dummy cutter unit DCU, which is a dummy of the cutter unit CU, can be attached to the attachment section AT. The dummy cutter unit DCU is a member attached to the attachment section AT instead of the cutter unit CU in order to put the printing device 1 into a usable state during a period in which the cutter unit CU is removed from the printing device 1 for reasons such as replacement of the cutter unit CU.

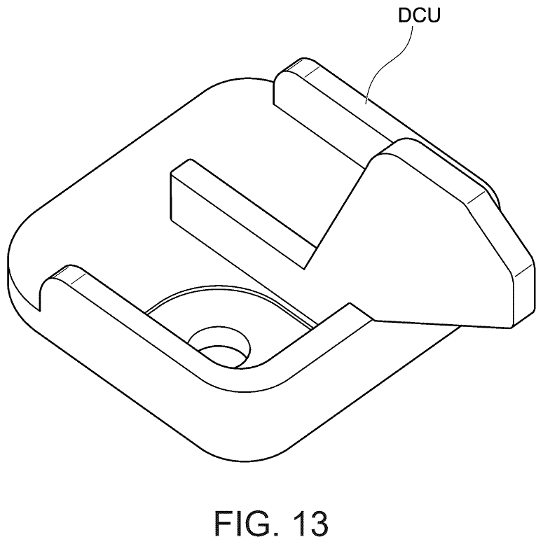

FIG. 13 is a diagram showing an example of a configuration of the dummy cutter unit DCU. The dummy cutter unit DCU is a member having substantially the same shape as the cutter unit CU with the movable blade BL1 removed. For this reason, the dummy cutter unit DCU can be attached to the attachment section AT. In process of attaching the dummy cutter unit DCU to the attachment section AT, the interference section IF1 moves from the obstructing position to the non-obstructing position. Therefore, the cover section CV can be displaced from the opened state to the closed state when the dummy cutter unit DCU is attached to the attachment section AT instead of the cutter unit CU, and cannot be displaced from the opened state to the closed state when the dummy cutter unit DCU is not attached to the attachment section AT instead of the cutter unit CU. By this, even in a state in which the cutter unit CU must be removed from the attachment section AT for some reason, the printing device 1 can execute functions other than cutting of the roll paper RP by the cutting section CT by attaching the dummy cutter unit DCU to the attachment section AT. The function other than cutting of the roll paper RP by the cutting section CT is, for example, a function of transporting the cut paper CP without using the cutting section CT, but is not limited thereto. As a situation in which the cutter unit CU must be removed from the attachment section AT, for example, as described above, replacement of the cutter unit CU or the like can be cited. When the cutter unit CU becomes unusable due to damage or the like, a user needs to replace it. However, if the user does not have a spare cutter unit, the printing device 1 cannot be used while the cutter unit CU is removed from the attachment section AT. Therefore, when the printing device 1 is provided with the dummy cutter unit DCU as described above, the printing device 1 can execute functions other than cutting of the roll paper RP by the cutting section CT by attaching the dummy cutter unit DCU to the attachment section AT. This leads to improvement in the usability of the printing device 1 and is useful.

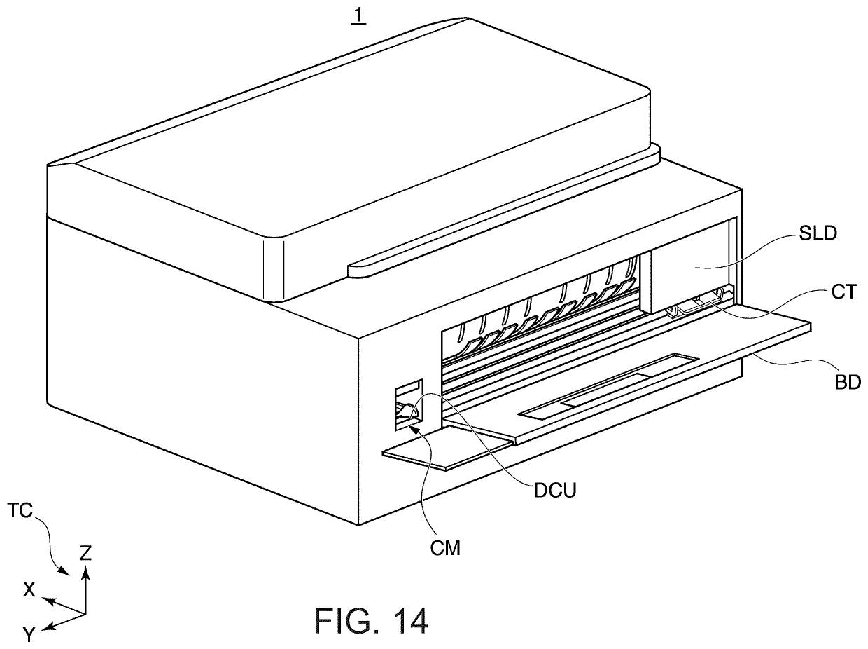

In a case where the printing device 1 is provided with the dummy cutter unit DCU as described above, the printing device 1 may be configured to be provided with an accommodation section CM that accommodates the dummy cutter unit DCU. FIG. 14 is a perspective view showing an example of the printing device 1 including the accommodation section CM. In the example shown in FIG. 14, the accommodation section CM is provided on the rear surface of the printing device 1. More specifically, the accommodation section CM is provided at a position that is on the rear surface of the printing device 1 covered by the opening and closing cover BD positioned at the closed position and that is on the rear surface of the printing device 1 not covered by the opening and closing cover BD positioned at the opened position. By this, the printing device 1 can prevent the dummy cutter unit DCU from being lost when the dummy cutter unit DCU is not in use. This allows a user to take out the dummy cutter unit DCU and attach the taken-out dummy cutter unit DCU to the attachment section AT without moving to the other side of the printing device 1 when removing the cutter unit CU from the attachment section AT. As a result, the printing device 1 can improve the usability of the printing device 1. Note that this is merely an example, and the accommodation section CM may be provided at another position on the rear surface of the printing device 1. For example, the accommodation section CM may be provided at a position on the rear surface of the printing device 1, which is not covered by the opening and closing cover BD positioned at both the opened position and the closed position. In this case, the accommodation section CM may include a configuration in which an openable cover is provided between a position that exposes the inside of the accommodation section CM and the position that does not expose the inside of the accommodation section CM.

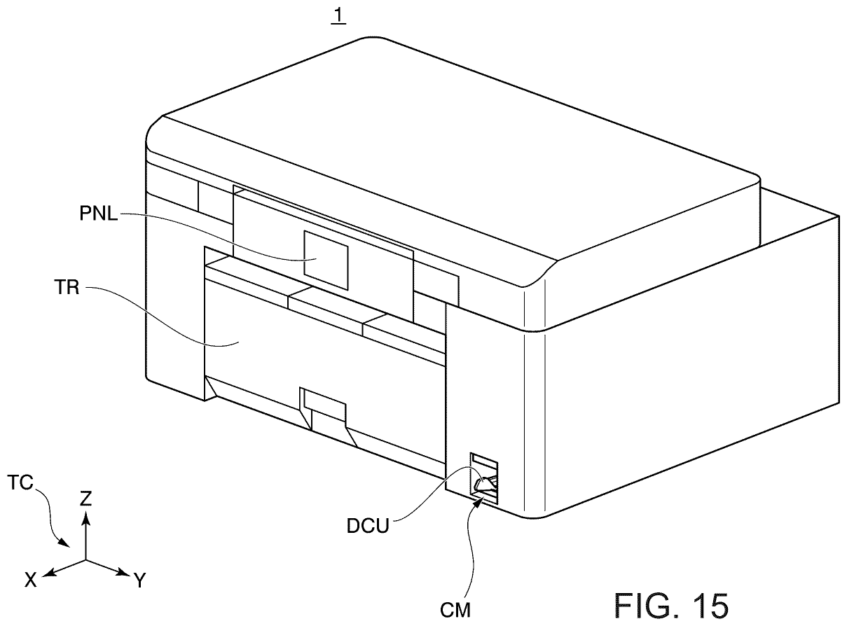

The accommodation section CM may be provided on another surface instead of the rear surface of the printing device 1. FIG. 15 is a perspective view showing an other example of the printing device 1 including the accommodation section CM. In the example shown in FIG. 15, the accommodation section CM is provided on the front surface of the printing device 1. More specifically, in the example, the accommodation section CM is provided adjacent to the paper feed tray TR. In this case, a user can take out the dummy cutter unit DCU while operating the printing device 1. More specifically, for example, the user can take out the dummy cutter unit DCU while performing an operation of instructing replacement of the cutter unit CU on the operation section PNL. This is useful for preventing the user from forgetting to take out the dummy cutter unit DCU. That is, the printing device 1 can improve the usability of the printing device 1. Even in this case, the opening and closing cover BD is provided on the rear surface of the printing device 1. Therefore, the printing device 1 can make it difficult for a user to open and close the opening and closing cover BD, and as a result, it is possible to suppress unintended contact between the cutting section CT and the user. This leads to suppression of occurrence of a failure in the cutting section CT due to contact with the user, which is useful. The printing device 1 may be configured to include a light emitting diode (LED) or the like that emits light indicating the position of accommodation section CM when the operation is received. In a case where the accommodation section CM is provided on the front surface of the printing device 1, the accommodation section CM may be provided with a cover which can be opened and closed between a position at which the inside of the accommodation section CM is exposed and a position at which the inside of the accommodation section CM is not exposed.

The printing device 1 may be configured to include a detection section that detects which of the cutter unit CU and the dummy cutter unit DCU is attached to the attachment section AT. In this case, for example, when the dummy cutter unit DCU is attached to the attachment section AT and an operation to use the cutting section CT is instructed, the printing device 1 can notify an error. The detection section can distinguish whether the unit attached to the attachment section AT is the cutter unit CU or the dummy cutter unit DCU, for example, according to the difference between the shape of the cutter unit CU and the shape of the dummy cutter unit DCU. The difference in these shapes is, for example, the presence or absence of a recess section, the presence or absence of a protrusion section, and the like, but is not limited thereto. The detection section may be a contact sensor, an optical sensor, or the like, but is not limited to these. The detection section may be configured to be provided in a member other than the mount section ST1, may be configured to be provided in the attachment section AT, or may include another configuration. The printing device 1 may be configured to detect which of the cutter unit CU and the dummy cutter unit DCU is attached to the attachment section AT depending on whether or not the dummy cutter unit DCU is accommodated in the accommodation section CM. In this case, for example, when the detection section detects that the dummy cutter unit DCU is accommodated in the accommodation section CM, the printing device 1 determines that the cutter unit CU is attached to the attachment section AT. On the other hand, in this case, for example, when the detection section detects that the dummy cutter unit DCU is not accommodated in the accommodation section CM, the printing device 1 determines that the dummy cutter unit DCU is attached to the attachment section AT. In this case, for example, the printing device 1 may be configured to notify an error when the detection section detects that the dummy cutter unit DCU is not accommodated in the accommodation section CM. This is a configuration in which even if the dummy cutter unit DCU is not accommodated in the accommodation section CM, the dummy cutter unit DCU is not necessarily attached to the attachment section AT, so that an error prompting a user to confirm is notified. The printing device 1 may be configured to display information indicating the usage state of each of the cutter unit CU and the dummy cutter unit DCU on the operation section PNL in accordance with the detection result by the detection section. The printing device 1 may be configured to cause an LED to emit light indicating the usage state of each of the cutter unit CU and the dummy cutter unit DCU in accordance with the detection result by the detection section. In this case, the printing device 1 includes an LED.

The accommodation section CM may be provided in the paper feed tray TR. In this case, the accommodation section CM may be provided in a dead space in the paper feed tray TR. If the printing device 1 includes an auto document feeder (ADF), the accommodation section CM may be configured to be provided inside a housing where the ADF is opened.

### Hardware Configuration of Printing Device

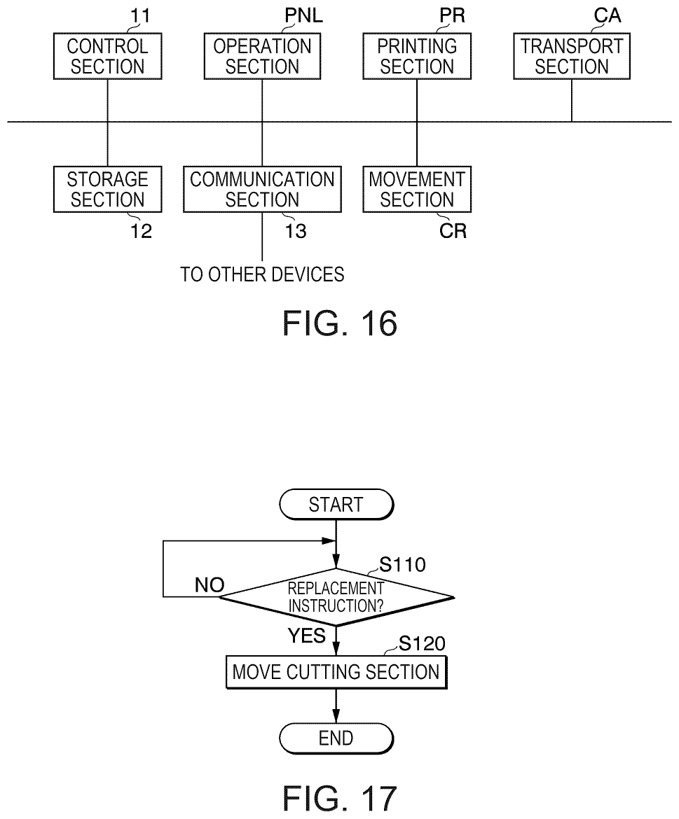

Hereinafter, a hardware configuration of the printing device 1 will be described with reference to FIG. 16. FIG. 16 is a diagram showing an example of a hardware configuration of the printing device 1.

The printing device 1 includes, for example, a control section 11, a storage section 12, a communication section 13, the operation section PNL, the printing section PR, the movement section CR, and the transport section CA. These components are communicably connected to each other via a bus. The printing device 1 communicates with another device such as an information processing device via the communication section 13. The information processing device is, for example, a laptop personal computer (PC), a desktop PC, a workstation, a tablet PC, a multifunctional mobile phone terminal (smartphone), a personal digital assistant (PDA), or the like, but is not limited thereto.

The control section 11 controls the entire printing device 1. The control section 11 includes, for example, a processor such as a central processing unit (CPU) or a field programmable gate array (FPGA). The control section 11 executes various processes performed by the printing device 1, for example, by executing various programs stored in the storage section 12.

The storage section 12 is a storage device including, for example, a hard disk drive (HDD), a solid state drive (SSD), an electrically erasable programmable read only memory (EEPROM), a read only memory (ROM), a random access memory (RAM), or the like. The storage section 12 may be an external storage device connected by a digital input/output port such as a universal serial bus (USB) instead of being built into the printing device 1. The storage section 12 stores various kinds of information, various kinds of images, and various kinds of programs to be processed by the printing device 1. That is, various kinds of information stored in the printing device 1 are stored in the storage section 12.

The communication section 13 is a communication device configured to include, for example, a digital input/output port such as a USB, an Ethernet (registered trademark) port, and an antenna for wireless communication.

### Process Performed by Printing Device when Operation of Instructing Replacement of Cutter Unit is Received

Hereinafter, with reference to FIG. 17, a description will be given of a process performed by the printing device 1 when an operation of instructing replacement of the cutter unit CU is received. FIG. 17 is a diagram showing an example of a process flow performed by the printing device 1 when an operation of instructing replacement of the cutter unit CU is received. Hereinafter, as an example, a case where the power of the printing device 1 is turned on at a timing before the process of step S110 shown in FIG. 17 is performed will be described.

The control section 11 stands by until an operation of instructing replacement of the cutter unit CU is received (step S110). In FIG. 17, the process of step S110 is indicated by “REPLACEMENT INSTRUCTION?”.

If the control section 11 determines that it receives an operation of instructing replacement of the cutter unit CU (YES in step S110), it controls the movement section CR to move the cutting section CT to the replacement position (step S120), and ends the process of the flowchart shown in FIG. 17. In FIG. 17, the process of step S120 is indicated by “MOVE CUTTING SECTION”.

By the above-described process, the printing device 1 can automatically move the cutting section CT to the replacement position without a user moving the cutting section CT, by receiving the operation of instructing replacement of the cutter unit CU. As a result, the printing device 1 can improve the usability of the printing device 1. Here, since the printing device 1 moves the cutting section CT to the replacement position by receiving the operation, it is possible to specify whether or not the cutter unit CU is properly attached to the attachment section AT by moving the cutting section CT from the replacement position to the home position. This leads to simplification of control for specifying whether or not the cutter unit CU is properly attached to the attachment section AT, and is useful. The printing device 1 may be configured to include a notification section that notifies when the cutting section CT does not return from the replacement position to the home position when the cutting section CT does not return from the replacement position to the home position. The notification section may be an LED, a display, a speaker, an oscillator, or another member capable of providing notification. In the printing device 1, a user may manually move the cutting section CT to the replacement position. In addition, as described above, at the home position, the cutter unit CU of the cutting section CT is covered by the restriction member SLD. This is useful because it leads to prompting the user to move the cutting section CT to the replacement position when replacing the cutter unit CU. The printing device 1 may be configured to include a detection section that detects opening and closing of the opening and closing cover BD. In this case, the printing device 1 may be configured to receive an operation of opening the rear surface opening by the opening and closing cover BD as an instruction for replacement of the cutter unit CU.

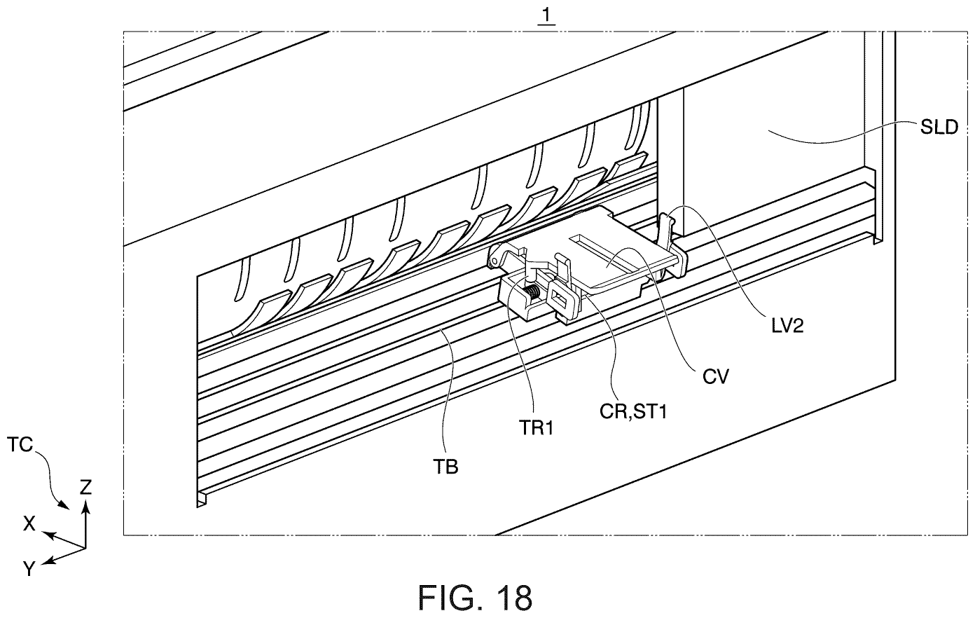

Here, when the cover section CV is not in the closed state, the cutting section CT, in movement by the movement section CR from the replacement position to the home position, as shown in FIG. 18, comes into contact with the restriction member SLD described above. FIG. 18 is a perspective view showing an example of a state in which the cover section CV, which is not in the closed state, is in contact with the restriction member SLD. In the example shown in FIG. 18, the second lever LV2 of the cover section CV is in contact with the restriction member SLD. By this, in the printing device 1, it is possible to realize the interference between the restriction member SLD and the cover section CV in a case where the cover section CV is not in the closed state without increasing the opening angle of the cover section CV with respect to the attachment section AT. As a result, the printing device 1 can suppress an increase in the length of the protrusion section TR1. This is useful for suppressing an increase in size of the cutting section CT and an increase in size of the printing device 1. A portion of the cover section CV that contacts the restriction member SLD may be a different portion instead of the second lever LV2. The second lever LV2 is an example of a contacted section. In this manner, the restriction member SLD restricts movement of the cover section CV, which is not in the closed state, by the movement section CR. On the other hand, the restriction member SLD does not restrict movement of the cover section CV in the closed state by the movement section CR. By this, the printing device 1 can specify that the cutter unit CU is not properly mounted on the mount section ST1. As a result, it is possible to prevent the printing device 1 from operating even when the cutter unit CU is not properly attached to the attachment section AT, that is, even when the cover section CV is not in the closed state. Here, a case where the cutter unit CU is not properly attached includes a state where the cutter unit CU is not supported at the attached position determined in advance for the cutter unit CU on the placement surface of the attachment section AT, a state where the cover section CV is not in the closed state although the cutter unit CU is supported at the position, a state where the cutter unit CU is not attached to the attachment section AT, and the like. As a result, even if a user does not notice that the cutter unit CU is not properly attached to the attachment section AT, the printing device 1 can prevent an operational failure from occurring. In the printing device 1, it is possible to suppress an increase in size of the cutter unit CU compared to a configuration in which the cutter unit CU interferes with the restriction member SLD in a case where the cutter unit CU is not properly attached to the attachment section AT. At least a part of the restriction member SLD may be provided so as to cover an upper side between the home position and the replacement position, together with an upper side of the home position.

As described above, the printing device 1 includes the transport section CA that transports the print medium; the cutting section CT that cuts the print medium transported by the transport section CA; and the movement section CR that reciprocates the cutting section CT in the movement direction intersecting the transport direction in which the print medium is transported, wherein the cutting section CT includes the cutter unit CU including the cutter, and the mount section ST1 to which the cutter unit CU is attachable and detachable, the mount section ST1 includes the attachment section AT to which the cutter unit CU is attached, the cover section CV configured to be displaced between the closed state in which the cover section CV covers the attachment section AT and the opened state in which the cover section CV does not cover the attachment section AT, and the interference section IF1 configured to move between the obstructing position where the interference section IF1 interferes with the cover section CV to obstruct displacement of the cover section CV from the opened state to the closed state, and the non-obstructing position where the interference section IF1 does not interfere with the cover section CV not to obstruct displacement of the cover section CV from the opened state to the closed state, and the interference section IF1 is positioned at the non-obstructing position when the cutter unit CU is attached to the attachment section AT, and is positioned at the obstructing position when the cutter unit CU is not attached to the attachment section AT. By this, the printing device 1 can be prevented from operation in a state in which the cutter unit CU is not properly mounted.

In the printing device 1 described above, the transport section CA, the cutting section CT, and the movement section CR may be configured as a medium transport device that transports the print medium. The medium transport device may be provided in another device that needs to transport a medium, instead of the printing device 1. In this case, the medium may be the same as the print medium or may be different from the print medium.

### First Modification of Embodiment

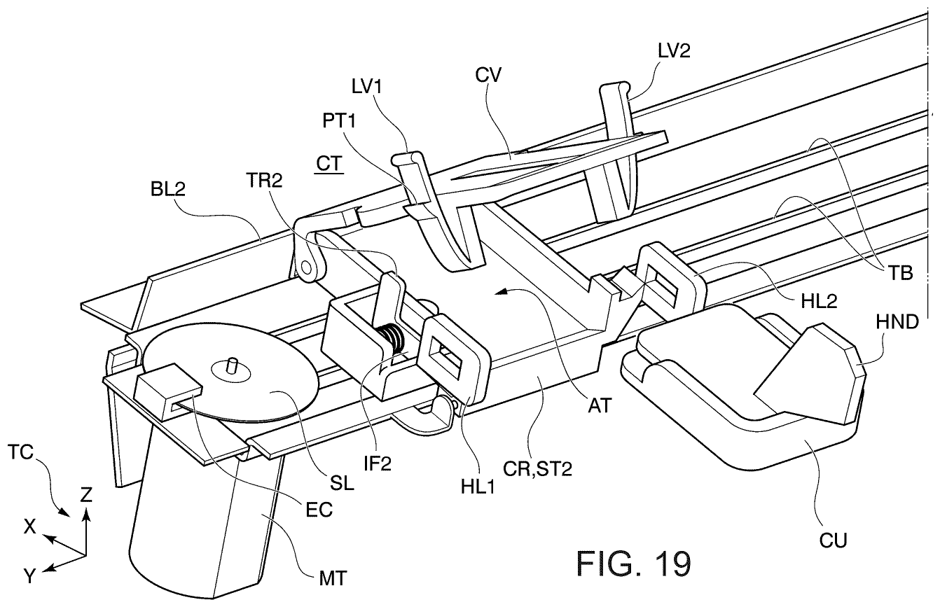

Hereinafter, a first modification of the embodiment will be described with reference to FIGS. 19 to 22. In the first modification of the embodiment, the cutting section CT includes a mount section ST2 instead of the mount section ST1. FIG. 19 is a perspective view showing an other example of a state of the cutting section CT when the cutter unit CU is replaced.

As shown in FIG. 19, the mount section ST2 includes the attachment section AT, the cover section CV, and an interference section IF2.

The interference section IF2, similar to interference section IF1, is a member that is movable between an obstructing position where the interference section IF2 interferes with the cover section CV to obstruct displacement of the cover section CV from the opened state to the closed state and a non-obstructing position where the interference section IF2 does not interfere with the cover section CV not to obstruct displacement of the cover section CV from the opened state to the closed state. Here, the interference section IF2 moves from the obstructing position to the non-obstructing position by being pushed by the cutter unit CU in process of attaching the cutter unit CU to the attachment section AT. By this, the cover section CV can be displaced from the opened state to the closed state without interfering with the interference section IF2. On the other hand, the interference section IF2 moves from the non-obstructing position to the obstructing position by a biasing member such as a spring in process in which the cutter unit CU is detached from the attachment section AT. By this, when the cutter unit CU is not attached to the attachment section AT, the cover section CV interferes with the interference section IF2 and cannot be displaced from the opened state to the closed state.

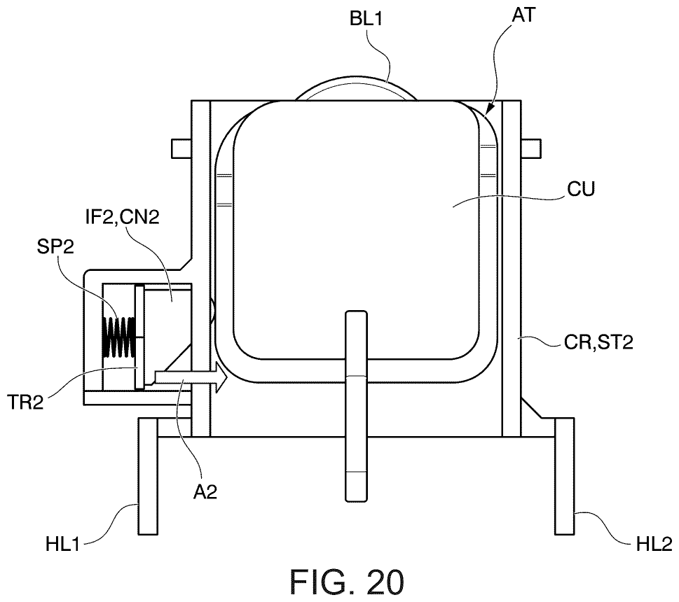

FIG. 20 is a top view showing an other example of the cutting section CT when the cutter unit CU is attached to the attachment section AT. However, in FIG. 20, the cover section CV is omitted in order to clearly show the positional relationship between the cutter unit CU and the interference section IF2.

As shown in FIG. 20, the interference section IF2 includes, for example, a contact member CN2 and a biasing member SP2. The interference section IF2 may include another member in addition to the contact member CN2 and the biasing member SP2.

The contact member CN2 is a member that can contact the cutter unit CU. In the example shown in FIG. 20, the contact member CN2 is a member that is biased by the biasing member SP2 toward a space in which the cutter unit CU is supported in the attachment section AT. That is, the biasing member SP2 is a member that biases the contact member CN2 toward a space in which the cutter unit CU is supported in the attachment section AT, and is, for example, a spring or the like, but is not limited thereto. In the printing device 1, since the interference section IF2 includes the biasing member SP2, it is possible to realize the interference between the interference section IF2 and the cover section CV in a case where the cutter unit CU is not attached to the attachment section AT with a simple configuration. The contact member CN2 is a member including a plate-shaped portion parallel to the placement surface of the attachment section AT. Here, as described above, the cutter unit CU is attached to the attachment section AT toward the mounting direction. The contact member CN2 is inclined so as to extend further toward a biasing direction A2, in which the biasing member SP2 biases the contact member CN2, as the contact member CN2 extends further toward the mounting direction. Therefore, the interference section IF2 is pushed by the cutter unit CU when a user slides the cutter unit CU on the placement surface toward the mounting direction, and moves in a direction opposite to the biasing direction A2. As a result, the interference section IF2 moves from the obstructing position to the non-obstructing position in process of attaching the cutter unit CU to the attachment section AT. This is useful because a user can easily notice that the cutter unit CU is not properly attached to the attachment section AT without lowering the mountability of the cutter unit CU. A position where the interference section IF2 shown in FIG. 20 is positioned is an example of the non-obstructing position.

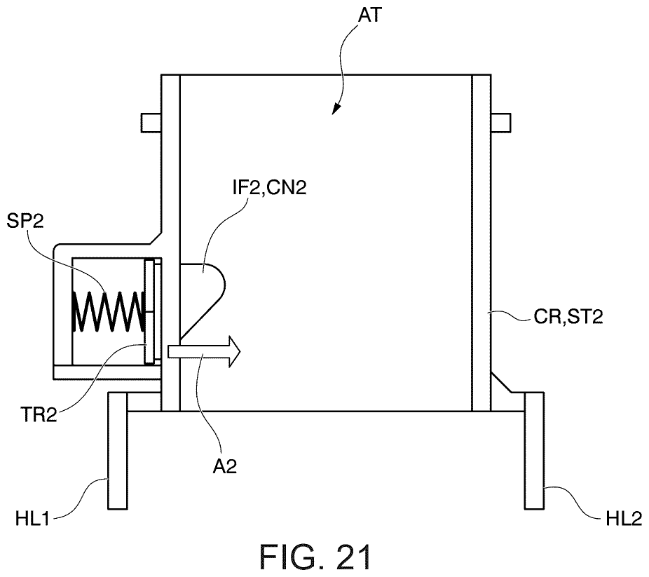

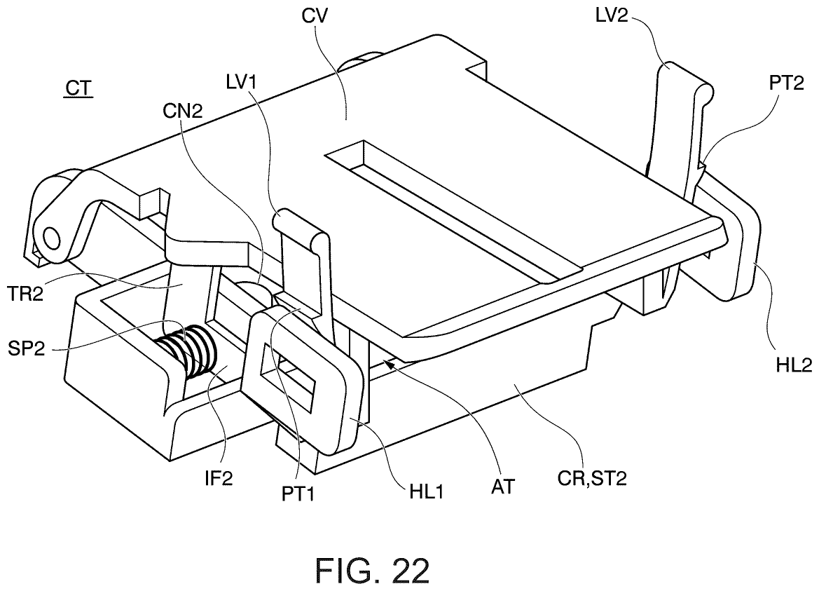

Unlike the contact member CN1, the contact member CN2 does not include an opening. Instead, the contact member CN2 includes a protrusion section TR2. The protrusion section TR2 is a portion of the contact member CN2 that protrudes in a protruding direction toward a space in which the cutter unit CU is supported in the attachment section AT, in a direction orthogonal to the placement surface. In the example shown in FIG. 20, the protrusion section TR2 protrudes toward the protruding direction from a end section of the contact member CN2 that is closest to a biasing member SP2 side. Therefore, in the first modification of the embodiment, the non-obstructing position is a position at which the protrusion section TR2 does not interfere with the cover section CV in displacement of the cover section CV from the opened state to the closed state. On the other hand, in the first modification of the embodiment, the obstructing position is a position at which the protrusion section TR2 interferes with the cover section CV in displacement of the cover section CV from the opened state to the closed state. The protrusion section TR2 interferes with the cover section CV when the contact member CN2 is not positioned at the non-obstructing position. As a result, in the case, the cover section CV cannot be displaced from the opened state to the closed state. FIG. 21 is a top view showing an other example of the cutting section CT when the cutter unit CU is not attached to the attachment section AT. However, in FIG. 21, in order to clearly show a position of the interference section IF2, the cover section CV is omitted. As shown in FIG. 21, in this case, the protrusion section TR2 is positioned on a biasing direction A2 side from a position of the protrusion section TR2 shown in FIG. 20. Therefore, as shown in FIG. 22, the protrusion section TR2 interferes with the cover section CV in displacement of the cover section CV from the opened state to the closed state. FIG. 22 is a perspective view showing an example of a state in which the protrusion section TR2 interferes with the cover section CV during displacement of the cover section CV from the opened state to the closed state. In the example shown in FIG. 22, the interference section IF2 is positioned at the obstructing position. In this case, the protrusion section TR2 interferes with the cover section CV during displacement of the cover section CV from the opened state to the closed state. As a result, as shown in FIG. 22, the cover section CV cannot be displaced from the opened state to the closed state. The protrusion section TR2 is an example of a second protrusion section. The contact member CN2 is an example of a second contact member. The biasing member SP2 is an example of a second biasing member.

In the printing device 1 including the cutting section CT with the mount section ST2 configured as described above, the interference section IF2 is positioned at the non-obstructing position when the cutter unit CU is attached to the attachment section AT, and is positioned at the obstructing position when the cutter unit CU is not attached to the attachment section AT. As a result, when the cutter unit CU is not attached to the printing device 1, the cover section CV cannot be displaced from the opened state to the closed state, so that a user can visually notice that the cutter unit CU is not attached to the attachment section AT. The case where the cutter unit CU is not attached is, for example, a case where a user forgets to mount the cutter unit CU. Therefore, the printing device 1 can be prevented from operating in a state where the cutter unit CU is not attached to the attachment section AT. This leads to suppression of the occurrence of an operational failure in the printing device 1 before starting the operation of the printing device 1, which is useful. The printing device 1 can be prevented from operation in a state in which the cutter unit CU is not properly mounted. Further, since the printing device 1 restricts movement of the movement section CR of the cover section CV when the cover section CV is not in the closed state, an operational failure can be prevented even if a user does not notice that the cutter unit CU is not attached to the attachment section AT.

In the first modification of the embodiment, the cover section CV may be configured to include an opening through which the protrusion section TR2 is inserted in the closed state. In this case, the protrusion section TR2, when the interference section IF2 is positioned in the non-obstructing position, is inserted into the opening, and if the interference section IF2 is not positioned in the non-obstructing position, without being inserted into the opening, the protrusion section TR2 interferes with the cover section CV.

### Second Modification of Embodiment

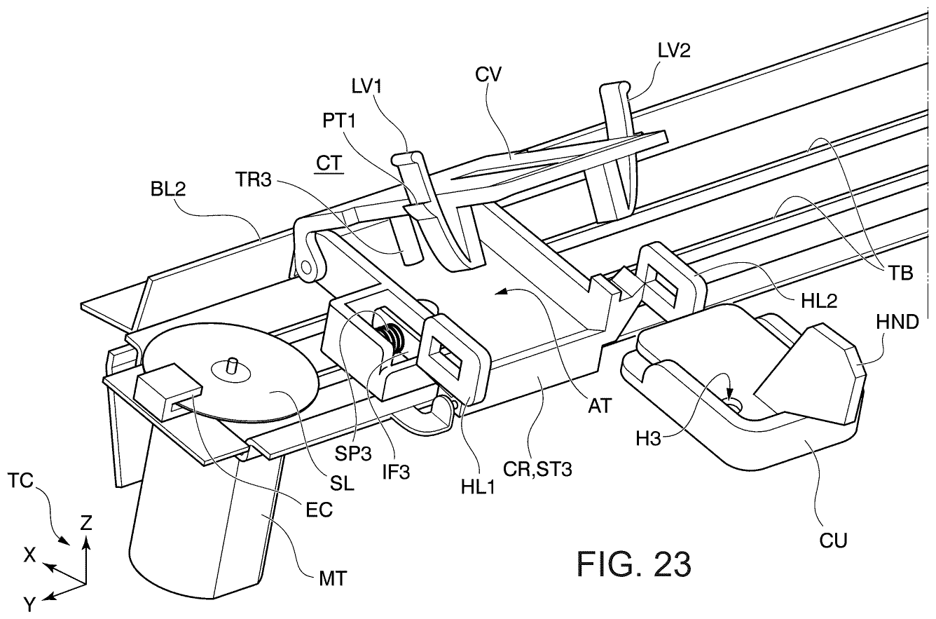

Hereinafter, a second modification of the embodiment will be described with reference to FIGS. 23 to 28. In a second modification of the embodiment, the cutting section CT includes a mount section ST3 instead of the mount section ST1. FIG. 23 is a perspective view showing still an other example of a state of the cutting section CT when the cutter unit CU is replaced.

As shown in FIG. 23, the mount section ST3 includes the attachment section AT, the cover section CV, and an interference section IF3.

The interference section IF3, similar to interference section IF1, is a member that is movable between an obstructing position where the interference section IF3 interferes with the cover section CV to obstruct displacement of the cover section CV from the opened state to the closed state and a non-obstructing position where the interference section IF3 does not interfere with the cover section CV not to obstruct displacement of the cover section CV from the opened state to the closed state. Here, the interference section IF3 moves from the obstructing position to the non-obstructing position by being pushed by the cutter unit CU in process of attaching the cutter unit CU to the attachment section AT. By this, the cover section CV can be displaced from the opened state to the closed state without interfering with the interference section IF3. On the other hand, the interference section IF3 moves from the non-obstructing position to the obstructing position by a biasing member such as a spring in process in which the cutter unit CU is detached from the attachment section AT. By this, when the cutter unit CU is not attached to the attachment section AT, the cover section CV interferes with the interference section IF3 and cannot be displaced from the opened state to the closed state.

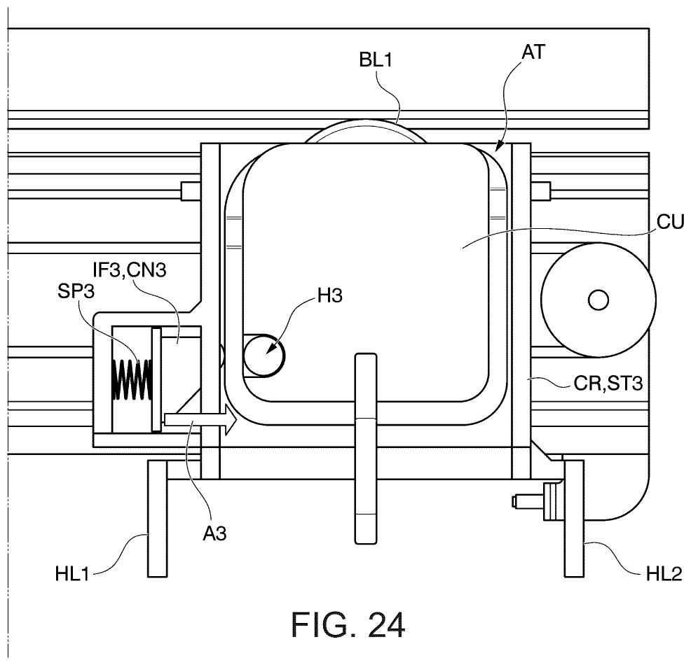

FIG. 24 is a top view showing still an other example of the cutting section CT when the cutter unit CU is attached to the attachment section AT. However, in FIG. 24, the cover section CV is omitted in order to clearly show the positional relationship between the cutter unit CU and the interference section IF3.

As shown in FIG. 24, the interference section IF3 includes, for example, a contact member CN3 and a biasing member SP3. The interference section IF3 may include another member in addition to the contact member CN3 and the biasing member SP3.

The contact member CN3 is a member that can contact the cutter unit CU. In the example shown in FIG. 24, the contact member CN3 is a member that is biased by the biasing member SP3 toward a space in which the cutter unit CU is supported in the attachment section AT. That is, the biasing member SP3 is a member that biases the contact member CN3 toward a space in which the cutter unit CU is supported in the attachment section AT, and is, for example, a spring or the like, but is not limited thereto. In the printing device 1, since the interference section IF3 includes the biasing member SP3, it is possible to realize the interference between the interference section IF3 and the cover section CV in a case where the cutter unit CU is not attached to the attachment section AT with a simple configuration. The contact member CN3 is a member including a plate-shaped portion parallel to the placement surface of the attachment section AT. Here, as described above, the cutter unit CU is attached to the attachment section AT toward the mounting direction. The contact member CN3 is inclined so as to extend further toward a biasing direction A3, in which the biasing member SP3 biases the contact member CN3, as the contact member CN3 extends further toward the mounting direction. Therefore, the interference section IF3 is pushed by the cutter unit CU when a user slides the cutter unit CU on the placement surface toward the mounting direction, and moves in a direction opposite to the biasing direction A3. As a result, the interference section IF3 moves from the obstructing position to the non-obstructing position in process of attaching the cutter unit CU to the attachment section AT. This is useful because a user can easily notice that the cutter unit CU is not properly attached to the attachment section AT without lowering the mountability of the cutter unit CU. A position where the interference section IF3 shown in FIG. 24 is positioned is an example of the non-obstructing position.

Unlike the contact member CN1, the contact member CN3 does not include an opening. Instead, in the second modification of the embodiment, the cutter unit CU include an opening H3. The opening H3 is an opening through which a protrusion section TR3 of the cover section CV is inserted. Here, the protrusion section TR3 is a portion that protrudes toward the placement surface in the cover section CV in the closed state among portions included in the cover section CV. The length of the protrusion section TR3 is, for example, a length in which the protrusion section TR3 is in contact with the placement surface when the cover section CV is in the closed state and is separated from the placement surface when the cover section CV is not in the closed state, but is not limited thereto.

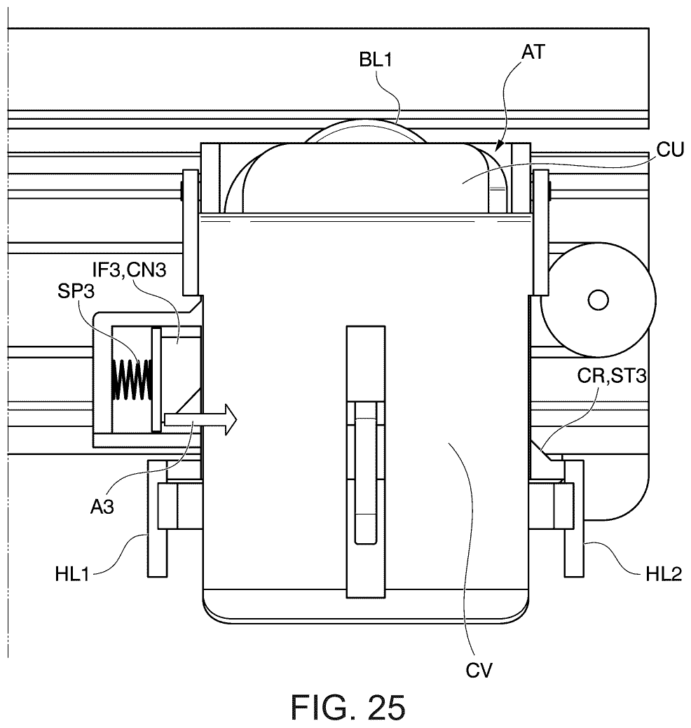

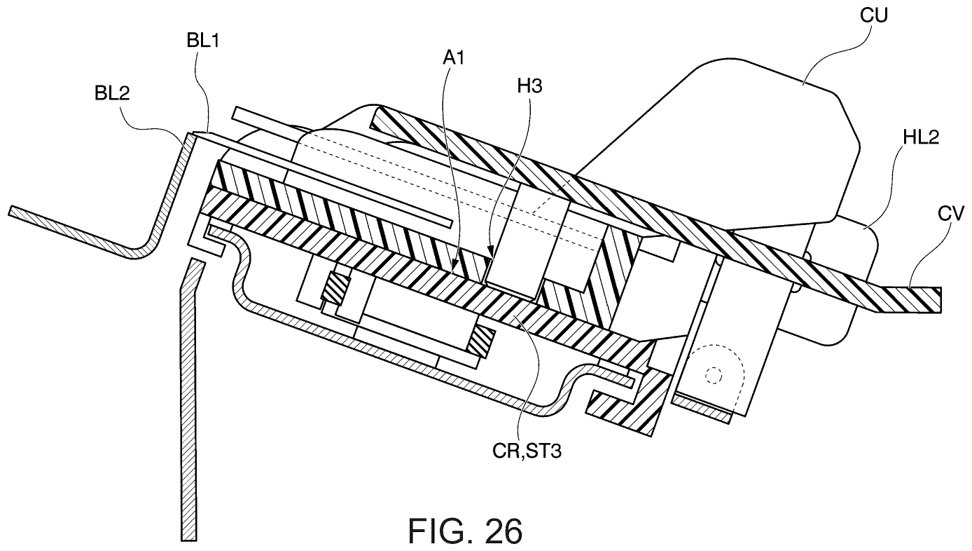

Here, in the second modification of the embodiment, the non-obstructing position is a position at which the protrusion section TR3 is inserted into the opening H3 in displacement of the cover section CV from the opened state to the closed state. Therefore, the protrusion section TR3 is inserted into the opening H3 when the cutter unit CU is attached to the attachment section AT, that is, when the contact member CN3 is positioned at the non-obstructing position. As a result, in this case, the cover section CV can be displaced from the opened state to the closed state. FIG. 25 is a top view showing an example of a state of the cutting section CT in which the cover section CV is in the closed state by inserting the protrusion section TR3 into the opening H3. FIG. 26 is a side cross-sectional view of the cutting section CT shown in FIG. 25. The position of the interference section IF3 shown in FIGS. 25 and 26 is an example of the non-obstructing position. As shown in FIG. 25 and FIG. 26, when the interference section IF3 is positioned at the non-obstructing position, the cutter unit CU is attached to the attachment section AT. Therefore, as shown in FIG. 26, the protrusion section TR3 of the cover section CV is inserted into the opening H3 of the cover section CV in displacement of the cover section CV from the opened state to the closed state. Therefore, as shown in FIGS. 25 and 26, the cover section CV can be displaced from the opened state to the closed state.

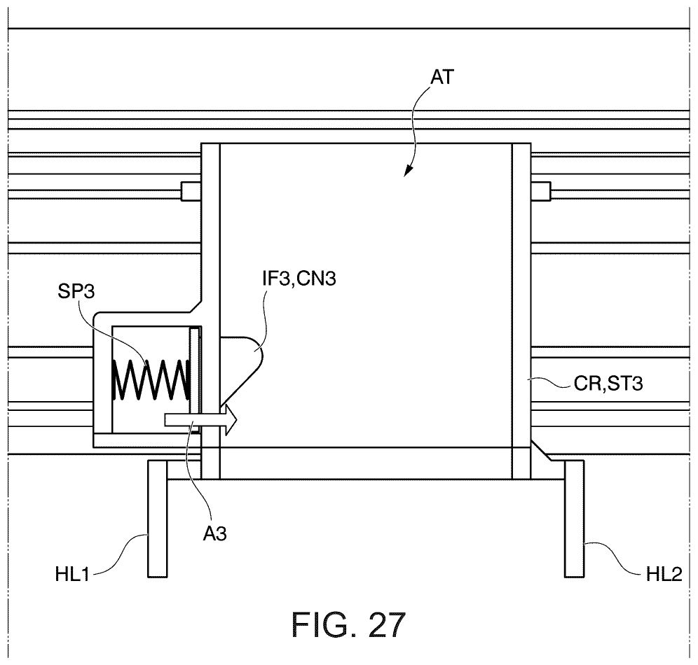

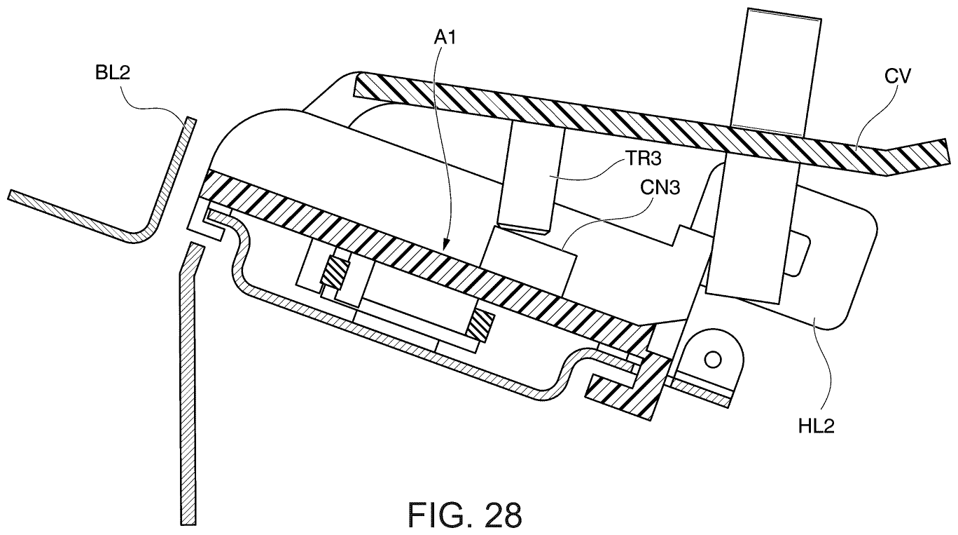

On the other hand, in the second modification of the embodiment, the obstructing position is a position at which the contact member CN3 is in contact with the protrusion section TR3 in displacement of the cover section CV from the opened state to the closed state. More specifically, in the second modification of the embodiment, the obstructing position is, as shown in FIG. 27, a position where a space in which the protrusion section TR3 of the cover section CV in the closed state exists and the contact member CN3 overlap. FIG. 27 is a top view showing still an other example of the cutting section CT when the cutter unit CU is not attached to the attachment section AT. For this reason, when the cutter unit CU is not attached to the attachment section AT, that is, when the contact member CN3 is not positioned at the non-obstructing position, the protrusion section TR3 is not inserted into the opening H3 and interferes with an upper surface of the contact member CN3 as shown in FIG. 28. As a result, in the case, the cover section CV cannot be displaced from the opened state to the closed state. FIG. 28 is a side cross-sectional view showing an example of a state in which the protrusion section TR3 interferes with the contact member CN3 during displacement of the cover section CV from the opened state to the closed state. The opening H3 is an example of a second opening. The protrusion section TR3 is an example of a third protrusion section. The contact member CN3 is an example of a third contact member. The biasing member SP3 is an example of a third biasing member.

In the printing device 1 including the cutting section CT with the mount section ST3 configured as described above, the interference section IF3 is positioned at the non-obstructing position when the cutter unit CU is attached to the attachment section AT, and is positioned at the obstructing position when the cutter unit CU is not attached to the attachment section AT. As a result, when the cutter unit CU is not attached to the printing device 1, the cover section CV cannot be displaced from the opened state to the closed state, so that a user can visually notice that the cutter unit CU is not attached to the attachment section AT. The case where the cutter unit CU is not attached is, for example, a case where a user forgets to mount the cutter unit CU. Therefore, the printing device 1 can be prevented from operating in a state where the cutter unit CU is not attached to the attachment section AT. This leads to suppression of the occurrence of an operational failure in the printing device 1 before starting the operation of the printing device 1, which is useful. Further, in the printing device 1, since the protrusion section TR3 is inserted into the opening H3 of the cutter unit CU, it is possible to facilitate the positioning of the cutter unit CU by a user. This is useful because it is possible to suppress a decrease in the cutting accuracy of the roll paper RP by the printing device 1 due to a decrease in the attachment accuracy of the cutter unit CU to the attachment section AT, for example, when the cutter unit CU is not attached to the predetermined position as the attached position of the cutter unit CU on the placement surface of the attachment section AT. In addition, in the printing device 1, it is possible to make a user aware that the cutter unit CU is not properly attached to the attachment section AT before the printing device 1 is operated. This makes it possible to suppress an increase in the total time required for printing an image on a print medium, as compared with a case where it is noticed after the operation of the printing device 1 that the cutter unit CU is not properly attached to the attachment section AT. Further, since the printing device 1 restricts movement of the movement section CR of the cover section CV when the cover section CV is not in the closed state, an operational failure can be prevented even if a user does not notice that the cutter unit CU is not attached to the attachment section AT.

The printing device 1 described above may include a configuration in which the cutting section CT cannot be moved to the home position unless the cover section CV in the opened state is engaged with the housing of the printing device 1 at the replacement position and the cover section CV is displaced from the opened state to the closed state. In this case, even if the cutter unit CU is not properly attached to the attachment section AT, there is no need to cause interference between the cover section CV and the restriction member SLD, and it is possible to prevent the occurrence of failures due to interference between the cover section CV and the restriction member SLD. In this case, since the printing device 1 can visually notify a user that the cutter unit CU has not been properly attached to the attachment section AT, it is not necessary to provide a notification section for notifying that the user that the cutter unit CU has not been properly attached to the attachment section AT.

The printing device 1 described above may be configured such that at the replacement position, the cover section CV, which is not in the closed state, interferes with the opening and closing cover BD, and the rear surface opening cannot be closed by the opening and closing cover BD unless the cover section CV is displaced from the opened state to the closed state. Also in this case, even if the cutter unit CU is not properly attached to the attachment section AT, it is not necessary to interfere with the cover section CV and the restriction member SLD, and it is possible to suppress the occurrence of failures due to the interference between the cover section CV and the restriction member SLD. Also in this case, since the printing device 1 can visually notify a user that the cutter unit CU has not been properly attached to the attachment section AT, it is not necessary to provide a notification section for notifying that the cutter unit CU has not been properly attached to the attachment section AT.

The matters described above may be combined in any way.

### NOTES

(1)
A medium transport device includes a transport section that transports a medium; a cutting section that cuts the medium transported by the transport section; and a movement section that reciprocates the cutting section in a movement direction intersecting a transport direction in which the medium is transported, wherein the cutting section includes a cutter unit including a cutter and a mount section to which the cutter unit is attachable and detachable, the mount section includes an attachment section to which the cutter unit is attached, a cover section configured to be displaced between a closed state in which the cover section covers the attachment section and an opened state in which the cover section does not cover the attachment section, and an interference section configured to move between an obstructing position where the interference section interferes with the cover section to obstruct displacement of the cover section from the opened state to the closed state, and a non-obstructing position where the interference section does not interfere with the cover section not to obstruct displacement of the cover section from the opened state to the closed state, and the interference section is positioned at the non-obstructing position when the cutter unit is attached to the attachment section, and is positioned at the obstructing position when the cutter unit is not attached to the attachment section.
(2)
The medium transport device according to (1), wherein the interference section includes a first opening, the cover section includes a first protrusion section, the non-obstructing position is a position at which the first protrusion section is inserted into the first opening in displacement of the cover section from the opened state to the closed state, and the obstructing position is a position at which the first protrusion section is not inserted into the first opening in displacement of the cover section from the opened state to the closed state.
(3)
The medium transport device according to (1), wherein the interference section includes a second protrusion section, the non-obstructing position is a position at which the second protrusion section does not interfere with the cover section in displacement of the cover section from the opened state to the closed state, and the obstructing position is a position at which the second protrusion section interferes with the cover section in displacement of the cover section from the opened state to the closed state.
(4)
The medium transport device according to (1), wherein the cutter unit includes a second opening, the cover section includes a third protrusion section that is inserted into the second opening in displacement of the cover section from the opened state to the closed state, the non-obstructing position is a position at which the interference section does not close the second opening, and the obstructing position is a position at which the interference section closes the second opening.
(5)
The medium transport device according to (2), wherein the interference section includes a first contact member that includes the first opening and configured to contact the cutter unit and a first biasing member that biases the first contact member toward a space in which the cutter unit is supported in the attachment section.
(6)
The medium transport device according to (3), wherein the interference section includes a second contact member provided with the second protrusion section and configured to contact the cutter unit and a second biasing member that biases the second contact member toward a space in which the cutter unit is supported in the attachment section.
(7)
The medium transport device according to (4), wherein the interference section includes a third contact member configured to contact the cutter unit and a third biasing member that biases the third contact member toward a space in which the cutter unit is supported in the attachment section and the third contact member does not close the second opening at the non-obstructing position, and closes the second opening at the obstructing position.
(8)
The medium transport device according to (5), wherein the cutter unit is attached to the attachment section towards a predetermined mounting direction and the first contact member is inclined so as to extend further toward a first biasing direction, in which the first biasing member biases the first contact member, as the first contact member extends further toward the mounting direction.
(9)
The medium transport device according to (6), wherein the cutter unit is attached to the attachment section towards a predetermined mounting direction and the second contact member is inclined so as to extend further toward a second biasing direction, in which the second biasing member biases the second contact member, as the second contact member extends further toward the mounting direction.
(10)
The medium transport device according to (7), wherein the cutter unit is attached to the attachment section towards a predetermined mounting direction and the third contact member is inclined so as to extend further toward a third biasing direction, in which the third biasing member biases the third contact member, as the third contact member extends further toward the mounting direction.
(11)
The medium transport device according to any one of (1) to (10) further includes a restriction member that restricts movement of the cover section by the movement section when the cover section is not in the closed state, and that does not restrict movement of the cover section by the movement section when the cover section is in the closed state, wherein the restriction member is provided above a movement path of the cutting section.
(12)
The medium transport device according to (11), wherein the cover section includes a contacted section extending upward and when the cover section is in the opened state, the contacted section comes into contact with the restriction member during movement of the cutting section by the movement section.
(13)
The medium transport device according to (11) or (12), wherein the cover section is configured to be displaced from the closed state to the opened state in a case where the cover section moves from a home position that is determined in advance as a position at which the cutting section starts an operation of cutting the medium to a replacement position that is determined in advance as a position at which the cutter unit is replaced and at least a part of the restriction member is provided so as to cover an upper side between the home position and the replacement position as well as an upper side of the home position.
(14)
The medium transport device according to (13) further includes a control section that moves the cutting section to the replacement position when an operation of instructing replacement of the cutter unit is received.
(15)
The medium transport device according to any one of (1) to (14) further includes a housing; an operation section that receives an operation; and an opening and closing cover configured to be opened and closed between an opened position that exposes the cutting section and a closed position that does not expose the cutting section, wherein the operation section is provided on a front surface of the housing and the opening and closing cover is provided on a rear surface of the housing.
(16)
The medium transport device according to any one of (1) to (15) further includes a dummy cutter unit that is configured to be attached to and detached from the mount section and that does not include a cutter, wherein the cover section is configured to be displaced from the opened state to the closed state when the dummy cutter unit is attached to the attachment section instead of the cutter unit, and is configured not to be displaced from the opened state to the closed state when neither the cutter unit nor the dummy cutter unit is attached to the attachment section.
(17)
The medium transport device according to (16) further includes an accommodation section that accommodates the dummy cutter unit.
(18)
The medium transport device according to (17) further includes a housing and an operation section that receives an operation, wherein the operation section is provided on a front surface of the housing and the accommodation section is provided on the front surface.
(19)
The medium transport device according to (17) further includes a housing and an opening and closing cover configured to be opened and closed between an opened position that exposes the cutting section and a closed position that does not expose the cutting section, wherein the opening and closing cover is provided on a rear surface of the housing and the accommodation section is provided at a position that is on the rear surface covered by the opening and closing cover positioned at the closed position and that is on the rear surface not covered by the opening and closing cover positioned at the opened position.
(20)
The medium transport device according to any one of (17) to (19) further includes a detection section that detects whether the cutter unit or the dummy cutter unit is attached to the attachment section.
(21)
The medium transport device according to any one of (17) to (20) further includes a paper feed tray configured to accommodate cut paper and roll paper as the medium.
(22)
A printing device includes the medium transport device according to any one of (1) to (21) and a printing section that prints an image on the medium transported by the transport section.

Although the embodiments of the present disclosure have been described in detail with reference to the drawings, specific configurations are not limited to these embodiments, and modifications, replacements, deletions, and the like may be made without departing from the spirit of the present disclosure.

A program for realizing a function of an arbitrary configuration section in the device described above may be recorded in a computer-readable recording medium, and the program may be read and executed by a computer system. Here, the device is, for example, the printing device 1 or the like. The term “computer system” as used herein includes an operating system (OS) and hardware such as peripheral devices. The “computer-readable recording medium” refers to a portable medium such as a flexible disk, an optical magnetic disk, a ROM, or a compact disk (CD)-ROM, or a storage device such as a hard disk built into the computer system. Further, the “computer-readable recording medium” includes a medium that holds a program for a certain period of time, such as a volatile memory inside a computer system serving as a server or a client when the program is transmitted via a network such as the Internet or a communication line such as a telephone line.

In addition, the program may be transmitted from a computer system in which the program is stored in a storage device or the like to another computer system via a transmission medium or by a transmission wave in the transmission medium. Here, the “transmission medium” for transmitting the program refers to a medium that has the function of transmitting information, such as a network like the Internet or a communication line such as a telephone line.

The above-described program may be one for realizing some of the previously mentioned functions. Furthermore, the above-described program may be a so-called differential file or differential program that can realize the previously mentioned functions in combination with a program already recorded in the computer system.

What is claimed is:

1. A medium transport device comprising:
a transport section that transports a medium;
a cutting section that cuts the medium transported by the transport section; and
a movement section that reciprocates the cutting section in a movement direction intersecting a transport direction in which the medium is transported, wherein
the cutting section includes
a cutter unit including a cutter and
a mount section to which the cutter unit is attachable and detachable, the mount section includes
an attachment section to which the cutter unit is attached,
a cover section configured to be displaced between a closed state in which the cover section covers the attachment section and an opened state in which the cover section does not cover the attachment section, and
an interference section configured to move between an obstructing position where the interference section interferes with the cover section to obstruct displacement of the cover section from the opened state to the closed state, and a non-obstructing position where the interference section does not interfere with the cover section not to obstruct displacement of the cover section from the opened state to the closed state, and
the interference section is positioned at the non-obstructing position when the cutter unit is attached to the attachment section, and is positioned at the obstructing position when the cutter unit is not attached to the attachment section.

2. The medium transport device according to claim 1, wherein
the interference section includes a first opening,
the cover section includes a first protrusion section,
the non-obstructing position is a position at which the first protrusion section is inserted into the first opening in displacement of the cover section from the opened state to the closed state, and
the obstructing position is a position at which the first protrusion section is not inserted into the first opening in displacement of the cover section from the opened state to the closed state.

3. The medium transport device according to claim 1, wherein
the interference section includes a second protrusion section,
the non-obstructing position is a position at which the second protrusion section does not interfere with the cover section in displacement of the cover section from the opened state to the closed state, and
the obstructing position is a position at which the second protrusion section interferes with the cover section in displacement of the cover section from the opened state to the closed state.

4. The medium transport device according to claim 1, wherein
the cutter unit includes a second opening,
the cover section includes a third protrusion section that is inserted into the second opening in displacement of the cover section from the opened state to the closed state,
the non-obstructing position is a position at which the interference section does not close the second opening, and
the obstructing position is a position at which the interference section closes the second opening.

5. The medium transport device according to claim 2, wherein
the interference section includes
a first contact member that includes the first opening and configured to contact the cutter unit and
a first biasing member that biases the first contact member toward a space in which the cutter unit is supported in the attachment section.

6. The medium transport device according to claim 3, wherein
the interference section includes
a second contact member provided with the second protrusion section and configured to contact the cutter unit and
a second biasing member that biases the second contact member toward a space in which the cutter unit is supported in the attachment section.

7. The medium transport device according to claim 4, wherein
the interference section includes
a third contact member configured to contact the cutter unit and
a third biasing member that biases the third contact member toward a space in which the cutter unit is supported in the attachment section and
the third contact member does not close the second opening at the non-obstructing position, and closes the second opening at the obstructing position.

8. The medium transport device according to claim 5, wherein
the cutter unit is attached to the attachment section towards a predetermined mounting direction and
the first contact member is inclined so as to extend further toward a first biasing direction, in which the first biasing member biases the first contact member, as the first contact member extends further toward the mounting direction.

9. The medium transport device according to claim 6, wherein
the cutter unit is attached to the attachment section towards a predetermined mounting direction and
the second contact member is inclined so as to extend further toward a second biasing direction, in which the second biasing member biases the second contact member, as the second contact member extends further toward the mounting direction.

10. The medium transport device according to claim 7, wherein
the cutter unit is attached to the attachment section towards a predetermined mounting direction and
the third contact member is inclined so as to extend further toward a third biasing direction, in which the third biasing member biases the third contact member, as the third contact member extends further toward the mounting direction.

11. The medium transport device according to claim 1, further comprising:
a restriction member that restricts movement of the cover section by the movement section when the cover section is not in the closed state, and that does not restrict movement of the cover section by the movement section when the cover section is in the closed state, wherein
the restriction member is provided above a movement path of the cutting section.

12. The medium transport device according to claim 11, wherein
the cover section includes a contacted section extending upward and
when the cover section is in the opened state, the contacted section comes into contact with the restriction member during movement of the cutting section by the movement section.

13. The medium transport device according to claim 11, wherein
the cover section is configured to be displaced from the closed state to the opened state in a case where the cover section moves from a home position that is determined in advance as a position at which the cutting section starts an operation of cutting the medium to a replacement position that is determined in advance as a position at which the cutter unit is replaced and
at least a part of the restriction member is provided so as to cover an upper side between the home position and the replacement position as well as an upper side of the home position.

14. The medium transport device according to claim 13, further comprising:
a control section that moves the cutting section to the replacement position when an operation of instructing replacement of the cutter unit is received.

15. The medium transport device according to claim 1, further comprising:
a housing;
an operation section that receives an operation; and
an opening and closing cover configured to be opened and closed between an opened position that exposes the cutting section and a closed position that does not expose the cutting section, wherein
the operation section is provided on a front surface of the housing and
the opening and closing cover is provided on a rear surface of the housing.

16. The medium transport device according to claim 1, further comprising:
a dummy cutter unit that is configured to be attached to and detached from the mount section and that does not include a cutter, wherein
the cover section is configured to be displaced from the opened state to the closed state when the dummy cutter unit is attached to the attachment section instead of the cutter unit, and is configured not to be displaced from the opened state to the closed state when neither the cutter unit nor the dummy cutter unit is attached to the attachment section.

17. The medium transport device according to claim 16, further comprising:
an accommodation section that accommodates the dummy cutter unit.

18. The medium transport device according to claim 17, further comprising:
a detection section that detects whether the cutter unit or the dummy cutter unit is attached to the attachment section.

19. The medium transport device according to claim 17, further comprising:
a paper feed tray configured to accommodate cut paper and roll paper as the medium.

20. A printing device comprising:
the medium transport device according to claim 1 and
a printing section that prints an image on the medium transported by the transport section.
